(19) United States
(12) Patent Application Publication
(10) Pub. No.: US 2024/0415104 A1
(43) Pub. Date: Dec. 19, 2024

(54) BAITCASTER WITH INTERNAL GEAR SET

(71) Applicant: TrikaUSA Inc., Superior, WI (US)

(72) Inventors: Larry Pulkrabek, Superior, WI (US); Ty Warner, Superior, WI (US); Danny Uribe, Superior, WI (US); Ron Hedberg, Superior, WI (US)

(21) Appl. No.: 18/819,267

(22) Filed: Aug. 29, 2024

Related U.S. Application Data
(63) Continuation-in-part of application No. 18/449,517, filed on Aug. 14, 2023, now Pat. No. 12,102,074.
Application No. 18/449,517 is a continuation of application No. 17/946,679, filed on Sep. 16, 2022, now Pat. No. 11,758,892.
Application No. 17/946,679 is a continuation of application No. 17/156,097, filed on Jan. 22, 2021, now Pat. No. 11,477,971.
Application No. 17/156,097 is a continuation of application No. 17/073,144, filed on Oct. 16, 2020, now Pat. No. 11,039,606.
(63) Continuation-in-part of application No. 18/458,346, filed on Aug. 30, 2023.
Application No. 18/458,346 is a continuation of application No. 17/073,137, filed on Oct. 16, 2020, now Pat. No. 11,785,928.
(63) Continuation-in-part of application No. 18/470,199, filed on Sep. 19, 2023.
Application No. 18/470,199 is a continuation of application No. 17/971,336, filed on Oct. 21, 2022, now Pat. No. 11,864,544.
Application No. 17/971,336 is a continuation of application No. 17/073,114, filed on Oct. 16, 2020, now Pat. No. 11,528,896.
(63) Continuation-in-part of application No. 18/738,878, filed on Jun. 10, 2024.
Application No. 18/738,878 is a continuation of application No. 18/096,277, filed on Jan. 12, 2023, now Pat. No. 12,041,921.
Application No. 18/096,277 is a continuation of application No. 17/188,867, filed on Mar. 1, 2021, now Pat. No. 11,559,051.
Application No. 17/188,867 is a continuation of application No. 17/072,902, filed on Oct. 16, 2020, now Pat. No. 11,154,042.
(60) Provisional application No. 62/916,574, filed on Oct. 17, 2019.
(60) Provisional application No. 62/916,439, filed on Oct. 17, 2019.
(60) Provisional application No. 62/916,513, filed on Oct. 17, 2019.
(60) Provisional application No. 62/916,458, filed on Oct. 17, 2019.

(51) Int. Cl. A01K 89/015

(52) U.S. Cl. CPC A01K 89/0183

(57) ABSTRACT

A baitcaster includes a spool, a guide member, and a line guide mechanism. The spool is configured to be driven to take up a fishing line. The guide member is configured to transition between a first state for let out of the fishing line and a second state for take up of the fishing line. The guide member configured to engage the fishing line at a contact point and guide the fishing line to the spool from the contact point when in the second state. The guide member is configured to be driven to rotate to reciprocatively translate the contact point along a length of the guide member. The line guide mechanism is configured to transition the guide member between the first state and the second state in response to a user input.

### CROSS-REFERENCE TO RELATED PATENT APPLICATION

The present application (i) is a continuation-in-part of U.S. application Ser. No. 18/449,517, filed Aug. 14, 2023, which is a continuation of U.S. application Ser. No. 17/946,679, filed Sep. 16, 2022, now U.S. Pat. No. 11,758,892, which is a continuation of U.S. application Ser. No. 17/156,097, filed Jan. 22, 2021, now U.S. Pat. No. 11,477,971, which is a continuation of U.S. application Ser. No. 17/073,144, filed Oct. 16, 2020, now U.S. Pat. No. 11,039,606, which claims the benefit of and priority to U.S. Provisional Application No. 62/916,574, filed Oct. 17, 2019, (ii) is a continuation-in-part of U.S. application Ser. No. 18/470,199, filed Sep. 19, 2023, which is a continuation of U.S. application Ser. No. 17/971,336, filed Oct. 21, 2022, now U.S. Pat. No. 11,864,544, which is a continuation of U.S. application Ser. No. 17/073,114, filed Oct. 16, 2020, now U.S. Pat. No. 11,528,896, which claims the benefit of and priority to U.S. Provisional Patent Application No. 62/916,513, filed Oct. 17, 2019, (iii) is a continuation-in-part of U.S. application Ser. No. 18/458,346, filed Aug. 30, 2023, which is a continuation of U.S. application Ser. No. 17/073,137, filed Oct. 16, 2020, now U.S. Pat. No. 11,785,928, which claims the benefit of and priority to U.S. Provisional Application. No. 62/916,439, filed Oct. 17, 2019, and (iv) is a continuation-in-part of U.S. Ser. No. 18/738,878, filed Jun. 10, 2024, which is a continuation of U.S. application Ser. No. 18/096,277, filed Jan. 12, 2023, now U.S. Pat. No. 12,041,921, which is a continuation of U.S. application Ser. No. 17/188,867, filed Mar. 1, 2021, now U.S. Pat. No. 11,559,051, which is a continuation of U.S. application Ser. No. 17/072,902, filed Oct. 16, 2020, now U.S. Pat. No. 11,154,042, which claims the benefit of and priority to U.S. Provisional Application No. 62/916,458, filed Oct. 17, 2019, the entire disclosures of all of which are incorporated by reference herein in their entireties.

### BACKGROUND

The present disclosure relates generally to fishing reels. More particularly, the present disclosure relates to baitcasting fishing reels.

### SUMMARY

At least one embodiment of the present disclosure relates to a baitcaster for retrieving a fishing line. The baitcaster includes a first frame member, a second frame member, a spool, and a guide member. The first frame member includes a first slot. The second frame member is positioned apart from the first frame member and includes a second slot. The spool is positioned between the first frame member and the second frame member. The spool is configured to be rotate about a spool axis to take up the fishing line. The guide member extends between the first slot of the first frame member and the second slot of the second frame member. The guide member is selectably transitionable between a first position and a second position along the first slot and the second slot. The guide member is configured to rotate about an axis extending centrally therethrough. The guide member is configured to engage the fishing line when in the second position and disengage the fishing line when transitioned into the first position.

Another embodiment of the present disclosure relates to a fishing rod. The fishing rod includes a rod and a baitcaster for retrieving a fishing line. The baitcaster includes a first frame member, a second frame member, a spool, and a guide member. The first frame member includes a first slot. The second frame member is positioned apart from the first frame member and includes a second slot. The spool is positioned between the first frame member and the second frame member. The spool is configured to be rotated about a spool axis to take up the fishing line. The guide member extends between the first slot of the first frame member and the second slot of the second frame member. The guide member is selectably transitionable between a first position and a second position along the first slot and the second slot. The guide member is configured to rotate about an axis extending centrally through the guide member. The guide member is configured to engage the fishing line when in the second position for take up of the fishing line and disengage the fishing line when transitioned into the first position for let out of the fishing line.

Another embodiment of the present disclosure relates to a baitcaster. The baitcaster includes a spool, a guide member, and a line guide mechanism. The spool is configured to be driven to take up a fishing line. The guide member is configured to transition between a first state for let out of the fishing line and a second state for take up of the fishing line. The guide member configured to engage the fishing line at a contact point and guide the fishing line to the spool from the contact point when in the second state. The guide member is configured to be driven to rotate to reciprocatively translate the contact point along a length of the guide member. The line guide mechanism is configured to transition the guide member between the first state and the second state in response to a user input.

Another embodiment of the present disclosure relates to a baitcaster. The baitcaster includes a body, a spool, a handle, and a drive. The body defines a proximate end and a distal end opposite the proximate end. The spool extends between the proximate end and the distal end. The handle extends from the proximate end and is configured to receive an input torque. The drive is configured to receive the input torque from the handle at the proximate end and drive the spool through a coupling at the distal end.

Another embodiment of the present disclosure relates to a fishing rod. The fishing rod includes a rod and a baitcaster coupled with the rod. The baitcaster includes a body, a spool, a handle, and a spool drive mechanism. The body defines a handle end and a distal end opposite the handle end. The spool extends between the handle end and the distal end. The handle extends from the handle end and is configured to receive an input torque. The spool drive mechanism is configured to receive the input torque from the handle at the handle end, and drive the spool through a coupling at the distal end.

Another embodiment of the present disclosure relates to a baitcaster. The baitcaster includes a body, a spool, and a spool drive mechanism. The body defines a handle end and a distal end opposite the handle end. The spool extends between the handle end and the distal end. The spool drive mechanism is configured to receive the input torque from a handle at the handle end, and drive the spool through a coupling at the distal end. The spool engagement mechanism is configured to selectively transition between a first state and a second state to fixedly couple or de-couple the spool with an output of the spool drive mechanism at the distal end of the baitcaster.

Another embodiment of the present disclosure relates to a baitcaster for retrieving a fishing line. The baitcaster includes a spool, and a compound gear set. The spool is configured to be driven to take up the fishing line. The compound gear set includes a ring gear, first planet gears, second planet gears, and a second shaft. The ring gear is configured to receive a torque from a first shaft. The first planet gears are driven by the ring gear. The second planet gears are driven by the second planet gears. The second shaft is driven by the second planet gears and is configured to drive the spool to take up the fishing line.

Another embodiment of the present disclosure relates to a compound gear set for a fishing reel. The compound gear set includes a ring gear, input planet gears, output planet gears, and an output shaft. The ring gear is configured to receive an input torque from an input shaft. The input planet gears are driven by the ring gear. The output planet gears are driven by the input planet gears. The output shaft is driven by the output planet gears and configured to drive a spool to take up the fishing line.

Another embodiment of the present disclosure relates to a gear set for a baitcaster. The gear set includes an input shaft, planet gear shafts, input planet gears, and output planet gears. The input shaft is configured to be driven by a handle about a shaft axis. The planet gear shafts are radially offset from the shaft axis, each define an axis, and are configured to be driven to rotate about the axis. Each of the input planet gears are fixedly coupled with a corresponding one of the plurality of planet gear shafts. The input planet gears are configured to be driven to rotate by the input shaft. Each of the output planet gears are fixedly coupled with a corresponding one of the planet gear shafts. The output planet gears are configured to drive an output shaft of the baitcaster.

Another embodiment of the present disclosure relates to a baitcaster for retrieving a fishing line. The baitcaster includes a housing, a spool, and a compound gear set. The spool is positioned at least partially within the housing, defining an inner volume, and includes a spindle. The compound gear set is positioned at least partially within the inner volume of the spool. The compound gear set is configured to receive input mechanical energy from a first shaft and transfer output mechanical energy through a second shaft to drive the spool and thereby retrieve the fishing line. The spindle is positioned centrally within the inner volume of the spool. The spindle is fixedly coupled with the spool through a central member. The central member extends radially outwards from the spindle and divides the inner volume into a first inner volume and a second inner volume. The spool also includes a straight portion, a first curved portion positioned at a first end of the straight portion, and a second curved portion positioned at a second end of the straight portion. A transition between the straight portion and the first curved portion divides the first inner volume into a first sub-volume and a second sub-volume. The compound gear set also includes a ring gear, input planet gears, output planet gears, and a carrier configured to support the input planet gears and the output planet gears.

Another embodiment of the present disclosure relates to a fishing rod. The fishing rod includes a rod and a baitcaster. The baitcaster is fixedly coupled with the rod and is configured to retrieve a fishing line that extends along the rod. The baitcaster includes a housing, a spool, and a compound gear set. The spool is positioned at least partially within the housing, defines an inner volume, and includes a spool shaft. The compound gear set is positioned at least partially within the inner volume of the spool. The compound gear set is configured to receive input mechanical energy from an input shaft and transfer output mechanical energy to the spool through an output shaft and the spool shaft to drive the spool to retrieve the fishing line. The spool shaft is positioned centrally within the inner volume of the spool. The spool shaft fixedly couples with the spool through a central member. The central member extends radially outwards from the spool shaft and divides the inner volume into a first inner volume and a second inner volume. The spool includes a straight portion, a first curved portion positioned at a first end of the straight portion, and a second curved portion positioned at a second end of the straight portion. A transition between the straight portion and the first curved portion divides the first inner volume into a first sub-volume and a second sub-volume. The compound gear set includes a ring gear, input planet gears, output planet gears, a carrier configured to support the input planet gears and the output planet gears, and an output shaft.

Another embodiment of the present disclosure relates to a gear set for a baitcaster. The gear set includes a ring gear, input planet gears, output planet gears, a carrier, and an output shaft. The input planet gears are configured to engage with the ring gear. The output planet gears are rotatably coupled with the input planet gears. The carrier is configured to support the input planet gears and the output planet gears. The output shaft is configured to drive a spool of the baitcaster. The gear set is positioned at least partially within an inner volume of the spool of the baitcaster at a first end of the baitcaster and configured to receive an input torque through a handle at the first end of the baitcaster and drive the spool through a coupling between the output shaft and the spool at a second end of the baitcaster.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a top view of a baitcaster including a line guide and a line guide mechanism, according to an exemplary embodiment.

FIG. 2 is a side view of the baitcaster of FIG. 1, according to an exemplary embodiment.

FIG. 3 is a perspective view of a portion of the baitcaster of FIG. 1, according to an exemplary embodiment.

FIG. 4 is a perspective view of the baitcaster of FIG. 1, according to an exemplary embodiment.

FIG. 5 is a perspective view of the baitcaster of FIG. 1, showing the line guide and the line guide mechanism in greater detail, according to an exemplary embodiment.

FIG. 6 is a perspective view of the baitcaster of FIG. 1, showing the line guide and the line guide mechanism in greater detail, according to an exemplary embodiment.

FIG. 7 is a perspective view of the baitcaster of FIG. 1, showing the line guide and the line guide mechanism in greater detail, according to an exemplary embodiment.

FIG. 8 is a perspective view of the line guide of the baitcaster FIG. 1, according to an exemplary embodiment.

FIG. 9 is a sectional view of the baitcaster of FIG. 1 including a spool drive mechanism and a spool engagement mechanism, according to an exemplary embodiment.

FIG. 10 is a perspective sectional view of the baitcaster of FIG. 9, showing the spool engagement mechanism in greater detail, according to an exemplary embodiment.

FIG. 11 is a sectional view of the baitcaster of FIG. 9, showing the spool engagement mechanism, according to an exemplary embodiment.

FIG. 12 is a perspective sectional view of the baitcaster of FIG. 1, showing the spool engagement mechanism, according to an exemplary embodiment.

FIG. 13 is a sectional view of the baitcaster of FIG. 1, showing the spool engagement mechanism, according to an exemplary embodiment.

FIG. 14 is a perspective sectional view of the baitcaster of FIG. 1, showing the spool engagement mechanism, according to an exemplary embodiment.

FIG. 15 is a sectional view of the baitcaster of FIG. 1 including a plunger sub-assembly, according to an exemplary embodiment.

FIG. 16 is a perspective exploded view of the plunger sub-assembly of FIG. 15, according to an exemplary embodiment.

FIG. 17 is a sectional view of the baitcaster of FIG. 1 including a spool drive mechanism, according to an exemplary embodiment.

FIG. 18 is a sectional view of the spool drive mechanism of the baitcaster of FIG. 17, according to an exemplary embodiment.

FIG. 19 is a perspective sectional view of a compound gear set that receives an input torque from a handle and outputs torque to a spool of the baitcaster of FIG. 1, according to an exemplary embodiment.

FIG. 20 is a sectional view of the baitcaster of FIG. 1, according to an exemplary embodiment.

FIG. 21 is a perspective sectional view of the baitcaster of FIG. 1, according to an exemplary embodiment.

FIG. 22 is a perspective sectional view of the baitcaster of FIG. 1, according to an exemplary embodiment.

FIG. 23 is a perspective view of the compound gear set of FIG. 19, according to an exemplary embodiment.

FIG. 24 is a perspective view of a portion of the baitcaster of FIG. 1, according to an exemplary embodiment.

FIG. 25 is a perspective view of a portion of the baitcaster of FIG. 1, according to an exemplary embodiment.

FIG. 26 is a schematic diagram of the compound gear set of FIG. 19, according to an exemplary embodiment.

FIG. 27 is a perspective view of the compound gear set of FIG. 19, according to an exemplary embodiment.

FIG. 28 is an exploded perspective view of the compound gear set of FIG. 19, according to an exemplary embodiment.

FIG. 29A is a perspective sectional view of the baitcaster of FIG. 17, including the spool drive mechanism positioned at least partially within an inner volume defined by a spool of the baitcaster, according to an exemplary embodiment.

FIG. 29B is a perspective sectional view of the baitcaster of FIG. 17, including the spool drive mechanism positioned at least partially within an inner volume defined by a spool of the baitcaster, according to an exemplary embodiment.

### DETAILED DESCRIPTION

Before turning to the FIGURES, which illustrate the exemplary embodiments in detail, it should be understood that the present application is not limited to the details or methodology set forth in the description or illustrated in the FIGURES. It should also be understood that the terminology is for the purpose of description only and should not be regarded as limiting.

### Overview

Referring generally to the FIGURES, a fishing reel includes an elongated member or a fishing rod and a baitcaster apparatus. The baitcaster apparatus is fixedly coupled with the fishing rod and is configured to receive a torque input from a user to retrieve or take-up fishing line that extends along the fishing rod. The fishing line may extend through one or more eyelets that are positioned along the fishing rod and guide the fishing line towards the baitcaster apparatus for winding or take-up onto a spool.

The baitcaster apparatus may include body members and structural members. The body members may be spaced apart and cooperatively define an inner volume in which a spool drive mechanism is disposed. The spool drive mechanism may receive rotational kinetic energy from an input shaft that includes a handle and protrudes or extends outwards from one side of the baitcaster apparatus. The spool drive mechanism may include a ring gear that drives the spool. A guide member can be positioned between the structural and body members and may be translatable between a take-up position and a let-out position along slots of the structural members. The guide member may be positioned such that fishing line passes over and engages the guide member before being provided to the spool. The guide member may contact the fishing line at a contact point. Rotation of the guide member produces reciprocating translation of the contact point back and forth along the guide member, thereby facilitating an even distribution of fishing line onto the spool.

The baitcaster apparatus may include a line guide mechanism that is configured to transfer rotational kinetic energy from the input shaft (e.g., that is used to drive the spool to take-up the fishing line) and drive the guide member. The line guide mechanism can be positioned within an inner volume defined by one of the structural members and one of the body members (e.g., on a handle-side of the baitcaster apparatus).

The line guide mechanism can include a first gear (e.g., a compound gear), a second gear, a first linkage, and a second linkage. The compound gear includes a first sub-gear and a second sub-gear. The first sub-gear is configured to engage radially outwards facing teeth of the ring gear to receive torque or rotational kinetic energy. The first sub-gear may be rotatably fixedly coupled with the second sub-gear so that the torque is transferred to the second sub-gear. The second sub-gear is configured to engage the second gear to transfer the rotational kinetic energy to the second gear. The second gear may be rotatably fixedly coupled with the guide member and may be translatable along the slots of the structural members. In this way, rotational kinetic energy can be transferred from the input shaft, through the spool drive mechanism, through the ring gear, through the compound gear, and to the second gear and the guide member.

The line guide mechanism may be configured to drive the guide member to rotate (as described above and in greater detail below) and may also be configured to drive the guide member to translate along the slots of the structural members between the take-up position and the let-out position. The first linkage may pivotally couple with the second gear so that the first linkage may drive or translate the second gear and the guide member. An opposite end of the first linkage pivotally couples with the second linkage, which may extend in a generally arcuate or circular shape around the input shaft and the ring gear. The first linkage can be coupled with a lever that extends between the structural members of the baitcaster apparatus. The lever may be translated, pressed, moved, etc., by the user to drive the first linkage and the second linkage to transition the guide member between the take-up position and the let-out position.

The spool drive mechanism can include a compound gear set. The compound gear set includes an input shaft that is configured to receive an input torque from the user through a handle. The input shaft may be fixedly rotatably coupled with a ring gear that includes radially inwards facing teeth. The radially inwards facing teeth are configured to engage multiple input planetary gears. The input planetary gears can each be fixedly coupled with planetary gear shafts that fixedly couple with output planetary gears. The input planetary gears, the planetary gear shafts, and the output planetary gears may be integrally formed with each other and can be supported by a carrier. The carrier may be rotatably fixedly coupled with a body or housing member of the baitcaster apparatus. The input planetary gears, the planetary gear shafts, and the output planetary gears may spin without orbiting about the input shaft.

The output planetary gears are configured to engage and drive an output shaft that extends along a same axis as the input shaft. The output shaft can be rotatably fixedly coupled with the spool to drive the spool to take up or let out the fishing line.

The spool drive mechanism can include a one-way bearing that is rotatably fixedly coupled with the input shaft. The one-way bearing may facilitate or allow rotation of the input shaft in a first direction (e.g., a take-up direction) but prevent rotation of the input shaft in a second, opposite, direction (e.g., a let-out direction). In some embodiments, the spool is selectively rotatably coupled with the input shaft so that the spool can be driven by the input shaft for winding the fishing line and free to rotate for letting out the fishing line.

The baitcaster apparatus may include body members and structural members. The body members may be spaced apart and cooperatively define an inner volume in which a spool drive mechanism is disposed. The spool drive mechanism can include a gear set positioned at least partially within the spool. The spool drive mechanism may include or be configured to interact with a spool engagement mechanism. The spool drive mechanism includes an input shaft that extends through a first side of the baitcaster (e.g., through the body and structural members on the first side) and is rotatably coupled (e.g., fixedly) with a handle. The handle may receive an input torque from the user to spin the input shaft. The input shaft transfers input torque received from the handle to the gear set that is positioned within the body and/or structural members or extends through the body and/or structural members. The gear set outputs torque through an output shaft. The spool can include a central portion or a spool shaft that includes teeth, engagement portions, interlocking portions, etc. The spool engagement mechanism includes a collar or an engagement member that is rotatably fixedly coupled with the output shaft, but is translatable along the output shaft. For example, the engagement member can include recesses and/or protrusions that extend longitudinally along an inner periphery or an inner surface of the engagement member. The output shaft may include corresponding longitudinal grooves and/or longitudinal protrusions that interlock with the recesses, grooves, protrusions, etc., of the engagement member. In this way, the engagement member and the output shaft may be rotatably fixedly coupled with each other, but translatable relative to each other (e.g., through a spline connection).

The engagement member may be selectably translatable along the output shaft between a first longitudinal position (e.g., a take-up position, an engaged position, etc.) and a second longitudinal position (e.g., a let-out position, a dis-engaged position, etc.). When the engagement member is in the first longitudinal position, the output shaft and the spool are rotatably fixedly coupled. When the engagement member is in the second longitudinal position, the output shaft and the spool are de-coupled from each other. In this way, translation of the engagement member between the first longitudinal position and the second longitudinal position can selectably rotatably fixedly couple the spool with the output shaft.

The engagement member can include a corresponding interfacing portion, teeth, interlocking members, longitudinal protrusions, longitudinal recesses, etc., that may be configured to interlock with the spool shaft when the engagement member is transitioned or translated into the first longitudinal position along the output shaft. In some embodiments, the baitcaster apparatus includes a lever, a bar, a button, etc., that can be depressed, moved, rotated, etc., by the user. In this way, the user may press, rotate, move, etc., the lever, bar, button, etc., to translate or transition the engagement member between the take-up position and the let-out position to selectably rotatably fixedly couple the spool with the output shaft. When the spool is rotatably de-coupled from the output shaft, the spool and the output shaft are free to rotate relative to each other.

The engagement member may rotatably fixedly couple with the spool at an end, side, or portion of the baitcaster apparatus that is opposite a handle side of the baitcaster apparatus. In this way, the baitcaster apparatus may receive input torque from a first side, while the spool is driven from a second, opposite, side of the baitcaster apparatus.

The spool may define an inner volume that is divided into a first inner volume and a second inner volume. The first inner volume can be portions within the spool that are on a handle side of a central structural member of the spool. The second inner volume can be portions within the spool that are on an opposite side of the central structural member of the spool. The spool may include a straight portion that is substantially cylindrical. The spool may include curved or arcuate end portions that facilitate preventing fishing line from falling off opposite ends of the spool. The spool can include a central spool shaft that includes an inner volume through which the output shaft extends. The output shaft may rotatably couple with the spool shaft through one or more ball bearings that are positioned within the spool shaft. The input planetary gears may be at least partially positioned within the first inner volume of the spool. The carrier, planet gear shafts, and output planet gears are completely positioned within the first inner volume of the spool. Positioning the compound gear set within the spool (e.g., within the first inner volume of the spool) facilitates a more compact and robust spool drive mechanism and baitcaster apparatus.

### Baitcaster

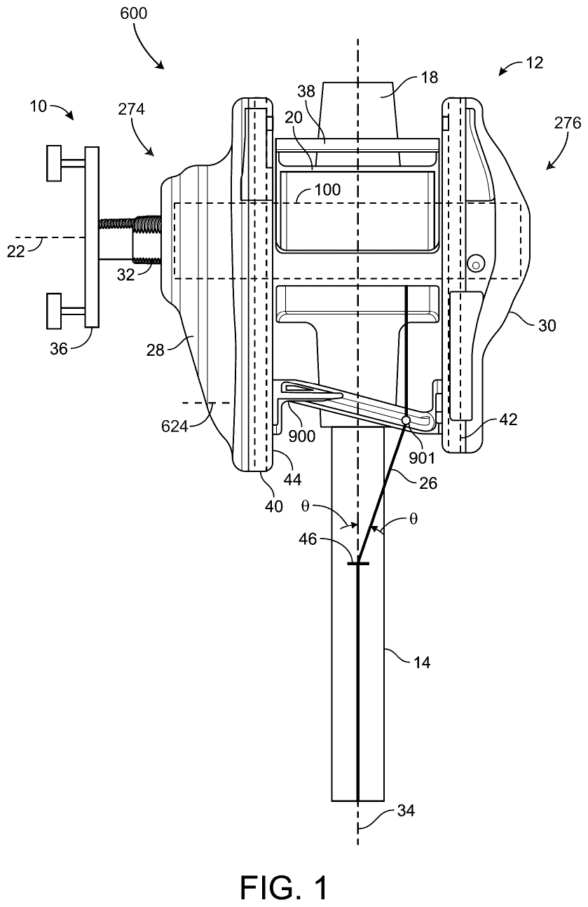

Referring particularly to FIGS. 1-3, a fishing reel, a baitcasting reel, a baitcaster, etc., shown as fishing reel 10 includes a rod, a pole, an elongated member, a flexible member, etc., shown as rod 14 and a reel apparatus, a reel mechanism, a reel assembly, a fishing line retrieval apparatus, etc., shown as reel 12. Reel 12 is fixedly coupled, attached, mounted, etc., with rod 14. In some embodiments, reel 12 is fixedly coupled with rod 14 through mounts, attachment members, etc., shown as mount 18. Mount 18 may extend from a bottom portion of reel 12 and fixedly couple with rod 14.

Reel 12 includes a spool, a barrel, a cylindrical member, etc., shown as spool 20. Spool 20 may be rotatably coupled with an input shaft, a rotatable shaft, a shaft, etc., shown as input shaft 32 such that spool 20 rotates when input shaft 32 is turned. In some embodiments, input shaft 32 is rotatably or fixedly coupled with a handle 36. An axis 22 (e.g., a spool axis, a shaft axis, a central axis, a longitudinal axis, an input axis, etc.) extends through input shaft 32 and spool 20. Input shaft 32 and spool 20 can be co-axial with each other about axis 22. Handle 36 facilitates an input torque to input shaft 32 about axis 22 for driving spool 20. In some embodiments, handle 36 and input shaft 32 are configured to rotate in a first direction (e.g., direction 24) to take-up fishing line 26 so that fishing line 26 is wound onto spool 20.

Fishing line 26 can extend along rod 14 and may be guided by one or more eyelets 46. Eyelets 46 can be positioned along rod 14 and can include an opening, a hole, an aperture, etc., through which fishing line 26 passes. Fishing line 26 may extend from an eyelet 46 that is most proximate reel 12 onto spool 20. Rod 14 defines a central axis 34 that extends longitudinally through a center of rod 14. Fishing line 26 may be guided from eyelet 46 that is most proximate reel 12 to spool 20. Fishing line 26 that is between the eyelet 46 most proximate reel 12 and central axis 34 may define an angle θ. The angle θ may change from a maximum positive value θ_{+,max} to a maximum negative value θ_{-,max} as fishing line 26 is taken up or reeled onto spool 20.

Reel 12 includes a first or a handle-side body member, housing member, structural member, etc., shown as first body member 28, and a second body member, housing member, structural member, etc., shown as second body member 30. First body member 28 and second body member 30 can define opposite sides of reel 12. Spool 20 can be positioned between first body member 28 and second body member 30 and may extend between first body member 28 and second body member 30. Spool 20 can be supported or rotatably coupled on either end with first body member 28 and second body member 30. Spool 20 may rotate relative to first body member 28 and second body member 30.

Reel 12 includes a guide member 900 that is configured to extend between first body member 28 and second body member 30 and be driven to rotate by rotation of handle 36. In some embodiments, guide member 900 is configured to engage fishing line 26 at a contact point 901. Fishing line 26 may be guided onto spool 20 from contact point 901. For example, fishing line 26 may extend from contact point 901 onto spool 20 where it is then wound onto spool 20. Rotation of guide member 900 can result in reciprocating translation of contact point 901. For example, as guide member 900 rotates, contact point 901 may shift back and forth along guide member 900 between opposite ends of guide member 900. In this way, fishing line 26 is guided and wound onto spool 20 along an entire longitudinal length of spool 20, thereby facilitating an even distribution of fishing line 26 on spool 20 and reducing knotting and/or bunching of fishing line 26 on spool 20 (e.g., an uneven distribution of fishing line 26). Evenly distributing and winding fishing line 26 on spool 20 can reduce a likelihood of fishing line 26 snagging, knotting, or becoming tangled when fishing line 26 is let out (e.g., released) from spool 20 (e.g., for casting operations).

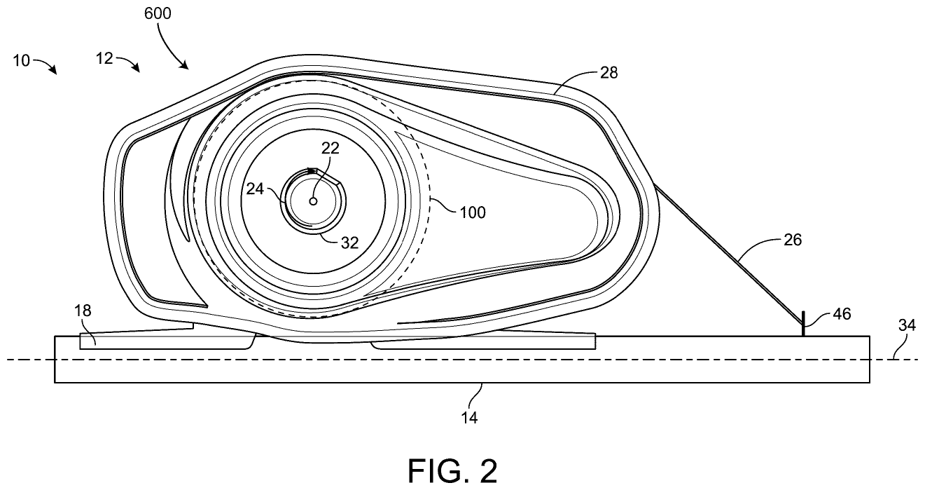

Referring still to FIGS. 1-2, input shaft 32 extends through first body member 28 and protrudes outwards from first body member 28. Handle 36 is coupled with input shaft 32 exterior of first body member 28 so that handle 36 can be operated by a fisherman's right hand while rod 14 is held by the fisherman's left hand. In other embodiments, input shaft 32 extends outwards through second body member 30 so that handle 36 is operated by the fisherman's left hand while rod 14 is held by the fisherman's right hand.

Input shaft 32 is configured to turn and drive rotation of spool 20 through a spool drive mechanism, a compound planetary gear assembly, a gear train, a gear assembly, etc., shown as spool drive mechanism 100. Spool drive mechanism 100 can be configured to receive torque from input shaft 32 and transfer the torque to spool 20 so that spool 20 rotates to take up or wind fishing line 26 onto spool 20.

Referring particularly to FIG. 1, reel 12 includes an input member, a bar, a rotatable linkage, a translatable member, a lever, a button, etc., shown as lever 38. Lever 38 may extend between first body member 28 and second body member 30 and may be pivotable, rotatable, and/or translatable between a first position and a second position (e.g., a first lever position and a second lever position). In some embodiments, lever 38 is configured to be transitioned between the first position and the second position to selectively couple input shaft 32 with spool 20.

Referring still to FIG. 1, reel 12 can include a first structural member, a first frame member, etc., shown as first frame member 40, and a second structural member, a second frame member, etc., shown as second frame member 42. First frame member 40 and second frame member 42 can be parallel with each other and may both extend in a longitudinal direction that is defined by central axis 34. First frame member 40 and second frame member 42 may be positioned within first body member 28 and second body member 30, respectively or may be positioned within an inner volume that is at least partially defined by first body member 28 and second body member 30.

Referring still to FIG. 1, reel 12 can include a central body member, a central housing, etc., shown as body member 44. In some embodiments, body member 44 extends between first body member 28 and second body member 30. First body member 28 and body member 44 may cooperatively define a first inner volume in which first frame member 40 is positioned. Second body member 30 and body member 44 may cooperatively define a second inner volume in which second frame member 42 is positioned.

### Line Guide

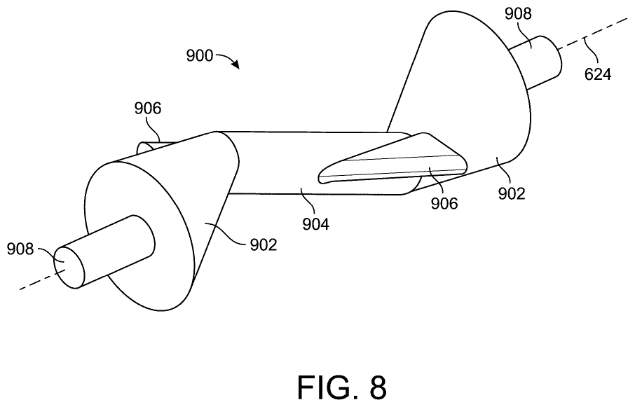

Referring particularly to FIGS. 1 and 8, guide member 900 can be fixedly coupled on a shaft 908 and driven to rotate about an axis 624 that extends longitudinally and centrally through guide member 900. Guide member 900 can be positioned such that guide member 900 is parallel with axis 22. In some embodiments, axis 34 extends through guide member 900 in a lateral direction (e.g., in a direction that is perpendicular to axis 22). Guide member 900 can be rotated and define one or more surfaces that engage fishing line 26 before it is fed to spool 20. Guide member 900 can be driven to rotate in a single direction by handle 36 (e.g., through line guide mechanism 600). As guide member 900 rotates, fishing line 26 engages the one or more surfaces of guide member 900 and translationally reciprocates fishing line 26 back and forth along guide member 900. This facilitates an even distribution of fishing line 26 onto spool 20.

Guide member 900 includes a pair of elongated members, shaft members, etc., shown as axles 908 at opposite ends of guide member 900. Axles 908 can be configured to each be received within a corresponding aperture, bearing, receiving portion, etc., of first body member 28 and second body member 30. Guide member 900 can be supported between first body member 28 and second body member 30 through axles 908 at each end. Axles 908 can rotatably couple with first body member 28 and second body member 30 such that guide member 900 rotates relative to first body member 28 and second body member 30.

Axles 908 can extend from frustum-shaped collars 902 that are asymmetric relative to an axis of rotation of guide member 900 (e.g., axis 624). A central section, portion, segment, etc., shown as central segment 904 is disposed between collars 902 that extends obliquely or diagonally through axis 52. A transition segment or fillet 906 connects each opposed end of central segment 904 to its respective collar 902. Transition segments 906 define line engaging surfaces that can be co-planar or in planes that are parallel with each other.

As guide member 900 rotates about axis 624 (e.g., being driven by or through line guide mechanism 600), fishing line 26 engages guide member 900 and is directed translationally back and forth along guide member 900. Guide member 900 can be rotated in a single direction (e.g., clockwise or counter-clockwise) such that fishing line 26 engages guide member 900 and is directed to different lateral positions on spool 20 in a repeating manner. Guide member 900 can be positioned ahead of spool 44 such that fishing line 26 engages and is directed by guide member 900 before being wound onto spool 20.

### Line Guide Mechanism

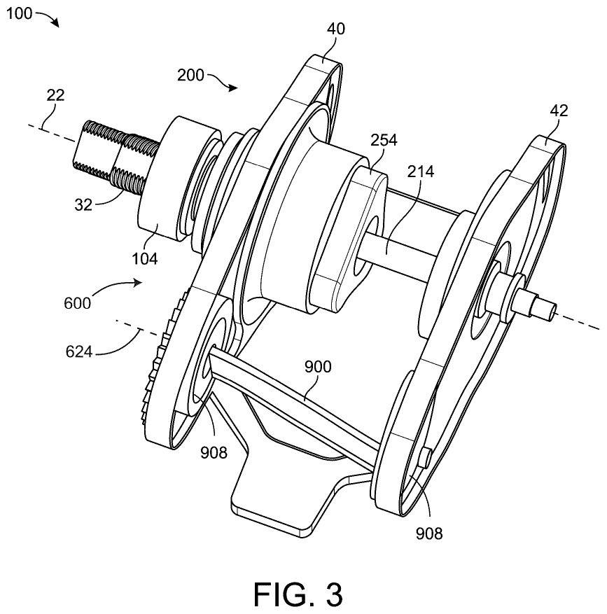

Referring particularly to FIGS. 3-7, line guide mechanism 600 is shown in greater detail, according to an exemplary embodiment. Line guide mechanism 600 can be positioned on a handle end 274 of baitcaster 12. In some embodiments, line guide mechanism 600 is positioned at handle end 274 of baitcaster 12 within an inner volume defined by first body member 28 and first frame member 40. Line guide mechanism 600 can be configured to transfer rotational kinetic energy from input shaft 32 to guide member 900 to rotate guide member 900 for take-up operations of baitcaster 12. In some embodiments, line guide mechanism 600 is also configured to transition guide member 900 between a first position, a first state, a take-up state, an engagement state, and a second position, a second state, a let-out state, a disengaged state, etc.

In some embodiments, first frame member 40 includes a rim, a peripheral protrusion, an annular protrusion, a circumferential protrusion, etc., shown as protrusion 634. Protrusion 634 extends longitudinally outwards and extends along an entire outer periphery of first frame member 40.

Line guide mechanism 600 may be contained or enclosed within first body member 28 and first frame member 40. In some embodiments, line guide mechanism 600 is configured to receive rotational kinetic energy (e.g., torque) from a ring gear 202 of spool drive mechanism 100. For example, ring gear 202 may be rotatably fixedly coupled or selectably rotatably fixedly coupled with input shaft 32 such that ring gear 202 rotates or turns with rotation or turning of input shaft 32.

Line guide mechanism 600 includes a compound gear 608 a second gear 606, a first linkage 602, a second linkage 604, and a release linkage 640. Compound gear 608, second gear 606, first linkage 602, second linkage 604, and release linkage 640 may be rotatably or pivotally coupled with first frame member 40 and can all be enclosed by first body member 28 and first frame member 40.

In some embodiments, compound gear 608 is rotatably coupled and translationally fixedly coupled with first frame member 40. For example, compound gear 608 may be free to rotate relative to first frame member 40. In some embodiments, compound gear 608 includes a shaft, a cylindrical member, an elongated member, etc., shown as shaft 614 that extends in a direction parallel with axis 22. Shaft 614 may extend towards distal end 276 of baitcaster 12 and can rotatably couple with first frame member 40 through a bearing, a ball bearing, a sleeve bearing, etc. In some embodiments, shaft 614 terminates within first frame member 40 or extends through first frame member 40.

Compound gear 608 can include a first sub-gear 610 and a second sub-gear 612. First sub-gear 610 may have a radius or a diameter that is greater than a radius of diameter of second sub-gear 612. First sub-gear 610 includes teeth 618 and second sub-gear 612 includes teeth 620. Teeth 618 of first sub-gear 610 may have a diametral pitch that is greater than a diametral pitch of teeth 620 of second sub-gear 612. First sub-gear 610 and second sub-gear 612 may be rotatably fixedly coupled with shaft 614 (e.g., integrally formed, press fit, keyed, frictionally fit, slip fit, etc.) so that first sub-gear 610 and second sub-gear 612 are translationally fixedly coupled with first frame member 40.

First sub-gear 610 is configured to engage, be driven by, mesh, interface with, etc., ring gear 202 through teeth 618 of first sub-gear 610 and teeth 616 of ring gear 202. In some embodiments, ring gear 202 rotates in a same direction as spool 20. For example, ring gear 202 may be rotatably fixedly coupled (e.g., selectably, adjustably, etc.) with spool 20 such that ring gear 202 and spool 20 rotate about axis 22 in unison. In some embodiments, rotation of input shaft 32 in direction 24 results in rotation of spool 20 and ring gear 202 in direction 25 about axis 22 (opposite direction 24).

Ring gear 202 may drive first sub-gear 610 and second sub-gear 612 to rotate about axis 622 in direction 656 through the engagement between ring gear 202 and first sub-gear 610. Second sub-gear 612 can, drive, rotate, etc., second gear 606 through engagement or meshing between teeth 620 of second sub-gear 612 and teeth 660 of second gear 606. In some embodiments, rotation of first sub-gear 610 about axis 622 drives rotation of second gear 606 about axis 624 in direction 658. In this way, compound gear 608 may be driven by ring gear 202 and drive second gear 606.

Second gear 606 can be translationally fixedly coupled with first frame member 40. In some embodiments, second gear 606 is also rotatably coupled with first frame member 40 such that second gear 606 may rotate relative to first frame member 40. Second gear 606 can be rotatably fixedly coupled with guide member 900 so that rotation of second gear 606 drives rotation of guide member 900 about axis 624. In some embodiments, axis 624 extends longitudinally through a shaft, a pin, an elongated member, a cylindrical member, etc., shown as shaft 626. Shaft 626 may be fixedly coupled (e.g., rotatably fixedly coupled, translationally fixedly coupled, etc.) with guide member 900 so that rotation of shaft 626 and second gear 606 drive rotation of guide member 900.

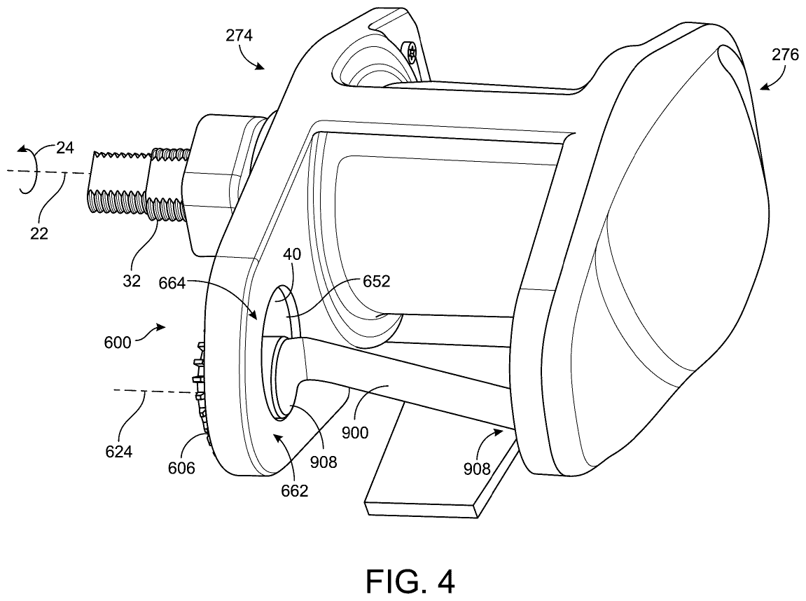

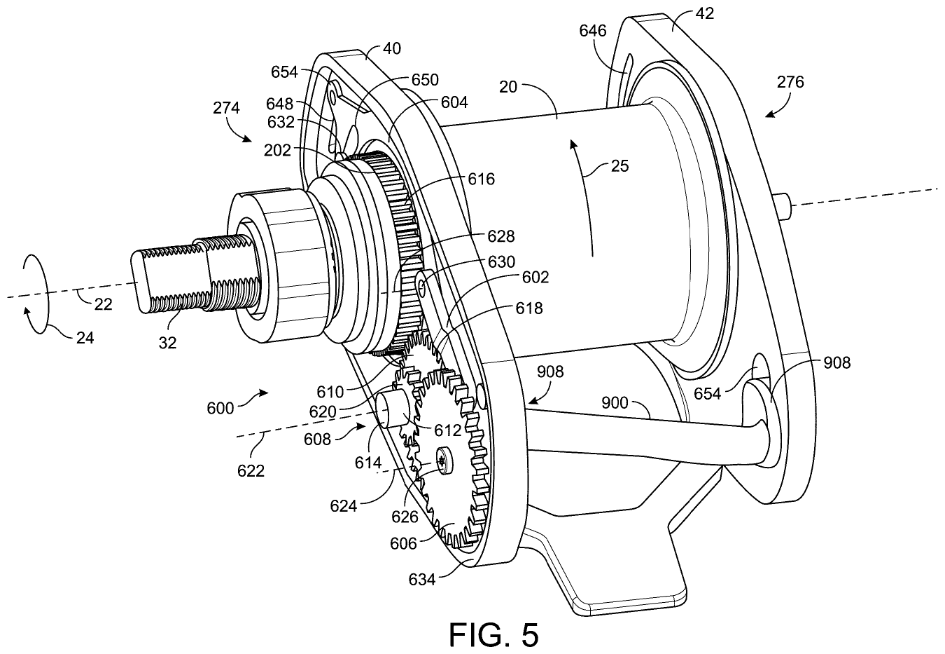

Referring particularly to FIGS. 4 and 5, first frame member 40 and second frame member 42 can each include a slot, opening, channel, aperture, etc., shown as first slot 652 and second slot 654. First slot 652 and second slot 654 can extend through an entire thickness of first frame member 40 and second frame member 42, respectively. First slot 652 and second slot 654 are configured to receive axles 908 therewithin. In some embodiments, first slot 652 and second slot 654 have a width that is substantially equal to a diameter of axles 908. First slot 652 and second slot 654 may have rounded ends that have a radius of curvature substantially equal to a radius of axles 908. In some embodiments, an outer surface or a radially outwards facing surface of axles 908 is slidably coupled with an inner surface of first slot 652 and second slot 654. Guide member 900 may rotate about axis 624 within first slot 652 and second slot 654.

In this way, turning input shaft 32 may drive guide member 900 to rotate during a take-up operation of reel 12. In some embodiments, spool 20 and ring gear 202 are selectably rotatably coupled with input shaft 32. For example, spool 20 and ring gear 202 may be de-coupled from input shaft 32 by moving, pivoting, translating, rotating, etc., lever 38 for let-out operations of reel 12 (e.g., to let out fishing line 26).

Referring to FIGS. 3-7, guide member 900 is translatable or transitionable along first slot 652 and second slot 654 between a first position (shown in FIGS. 3-7) at a lower portion, a bottom end, a first end, a proximate end, etc., of slots 652-654, shown as lower end 662, and a second position at an upper portion, an upper end, a second end, a proximate end, etc., of slots 652-654, shown as upper end 664. In some embodiments, guide member 900 is transitioned into the second position at upper end 664 of slots 652-654 for take-up operations of reel 12 (e.g., so that guide member 900 engages or guides fishing line 26 before it is provided or wound onto spool 20). Guide member 900 is transitioned into the first position at lower end 662 of slots 652-654 for let-out operations of reel 12 (e.g., so that guide member 900 does not engage or guide fishing line 26 as it is let-out or un-wound from spool 20). Guide member 900 can be driven to translate in direction 670 along slots 652-654 from the first position to the second position by movement of lever 38 through line guide mechanism 600.

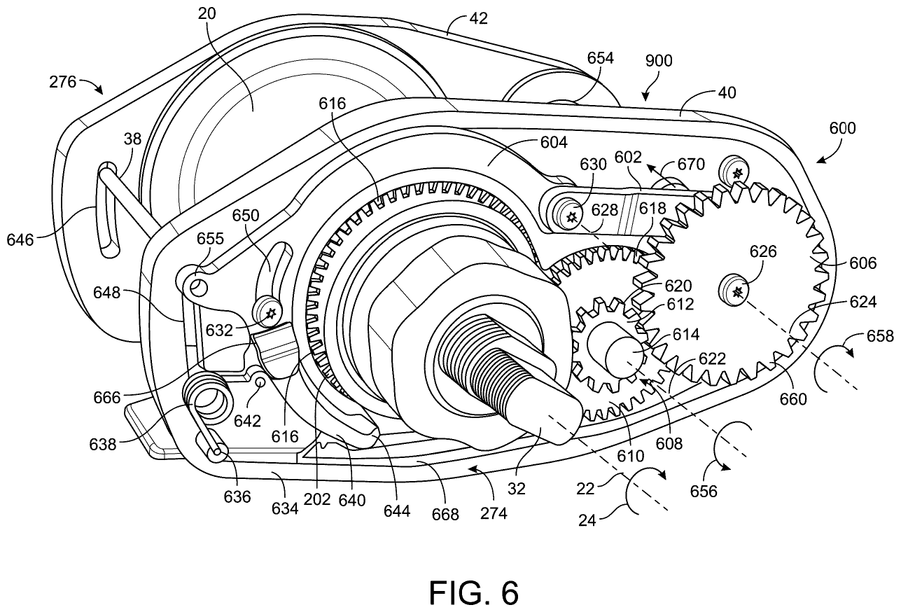

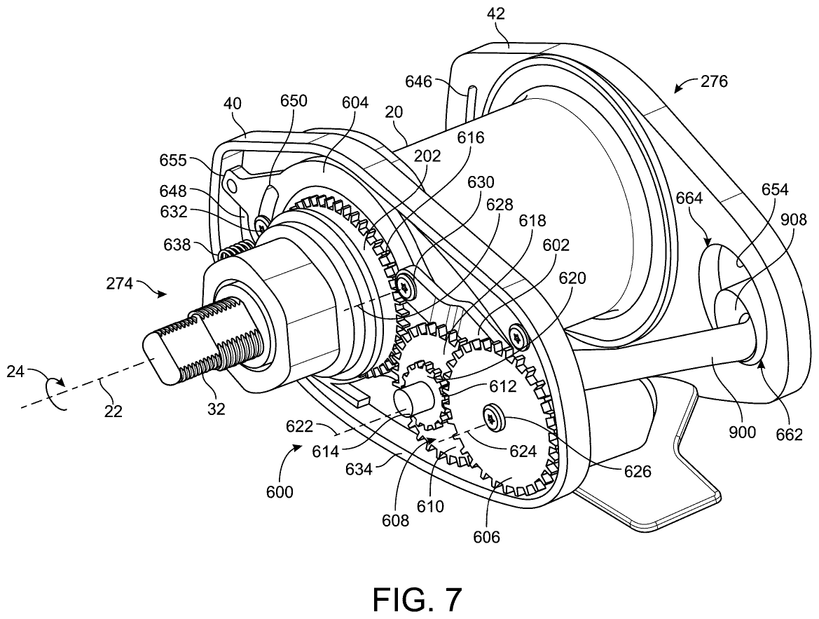

Referring particularly to FIGS. 6-7, first linkage 602 can be pivotally coupled with second linkage 604 at pivotal connection 630. In some embodiments, pivotal connection 630 defines an axis 628 about which first linkage 602 and second linkage 604 pivot. First linkage 602 extends between pivotal connection 630 and second gear 606. First linkage 602 pivotally couples with second linkage 604 at a first or proximate end, and pivotally couples with guide member 900, shaft 626, or second gear 606 at a second or distal end. First linkage 602 can have a generally straight or elongated shape that extends between pivotal connection 630 and second gear 606. Second linkage 604 may have a generally arcuate or curved shape that extends at least partially around ring gear 202. Second linkage 604 may include a first or proximate end that pivotally couples with first linkage 602, and a second or distal end that slidably and/or pivotally couples with a pin 632.

Second linkage 604 includes a protrusion, a tab, a flange, an engagement portion, a connection portion, etc., shown as lever engagement portion 655. Lever engagement portion 655 can be positioned at a second or distal end of second linkage 604. Lever engagement portion 655 may be aligned with or overlap with a slot 648 of first frame member 40. Slot 648 can be positioned at a rear portion of first frame member 40 and may have an arcuate or curved shape. In some embodiments, lever 38 extends through and slidably couples with slot 648. Lever 38 may fixedly couple with lever engagement portion 655 of second member 604 and may translate along slot 648. Second frame member 42 can also include a corresponding slot 646 that has a same shape as slot 648. Lever 38 may extend between first frame member 40 and second frame member 42 and slidably couple with first frame member 40 and second frame member 42. Lever 38 may be configured to translate along slots 646 and 648 between a first position at an upper end of slots 646 and 648 and a second position at a lower end of slots 646 and 648.

When lever 38 is at the first position (shown in FIGS. 6 and 7), guide member 900 is driven to the first position at lower end 662 of slots 652-654 for let-out operations of reel 12. When lever 38 is in the second position at the lower end of slots 646 and 648, guide member 900 is driven or translated to the second position at upper end 664 of slots 646 and 648 for take-up operations of reel 12. In this way, lever 38 can be transitioned or translated along slots 646 and 648 between the first position and the second position to transition guide member 900 between a position for take-up operations of reel 12 (e.g., to guide fishing line 26 onto spool 20) and a position for let-out operations of reel 12 (e.g., to let fishing line 26 unwind from spool 20).

Second linkage 604 may be driven to pivot about pivotal connection 630 or axis 628 by movement, translation, etc., of lever 38 along slots 646 and 648. For example, moving lever 38 downwards along slots 646 and 648 may pivot second linkage 604 in a counter-clockwise direction about axis 628, thereby loading first linkage 602 into tension. First linkage 602 may draw or pull guide member 900 and shaft 626 from the first position at lower end 662 to the second position at upper end 664 of slots 652-654.

In some embodiments, pin 632 is translationally fixedly coupled with first frame member 40 and extends or protrudes through a slot 650 (e.g., a guide slot) of second linkage 604. Pin 632 may guide a path of motion of second linkage 604 as second linkage 604 is driven to move, pivot, translate, etc., by lever 38. Slot 650 can be positioned on second linkage 604 proximate lever engagement portion 655 (e.g., at a rear end of reel 12, or at an end of reel 12 that is opposite the end where fishing line 26 is fed).

Second linkage 604 can also include an engagement portion, a protrusion, etc., shown as engagement portion 666. Engagement portion 666 is configured to directly contact, abut, engage, drive, etc., a corresponding portion of a release linkage 640. In some embodiments, engagement portion 666 is pivotally coupled with release linkage 640. Release linkage 640 of line guide mechanism 600 can function both as a locking linkage and a release linkage. In some embodiments, release linkage 640 is pivotally coupled with a torsional spring 638 at aperture 642. Aperture 642 may be proximate a portion of release linkage 640 that is driven by, contacted, or pivotally coupled with engagement portion 666. In some embodiments, release linkage 640 includes a hook, an engagement hook, etc., shown as hook 644 at an opposite end of release linkage 640. Hook 644 can be configured to engage, interlock with, mesh with, etc., teeth 616 of ring gear 202.

Release linkage 640 may be driven (e.g., by being rotated or pivoted) between a locked position (shown in FIG. 6) and a released position. When release linkage 640 is in the locked position, hook 644 engages teeth 616 of ring gear 202, thereby rotatably fixing ring gear 202 at a current angular position. When release linkage 640 is in the unlocked position, hook 644 is driven out of engagement with teeth 616 of ring gear 202, thereby allowing ring gear 202 to rotate. Release linkage 640 can be pivoted between the locked position and the released position by translation of lever 38 along slots 646-648. For example, when lever 38 is in the first position at the upper end of slots 646-648, hook 644 may be dis-engaged from teeth 616 of ring gear 202. When lever 38 is transitioned into the second position at the lower end of slots 646-648, hook 644 is to translate and pivot along a guide protrusion 668 of first frame member 40 that extends proximate protrusion 634.

A rear portion of hook 644 may slidably couple with, contact, engage, etc., a corresponding surface of first frame member 40 defined by guide protrusion 668. Moving lever 38 downwards along slots 646-648 drives release linkage 640 to translate and pivot relative to engagement portion 666 of second linkage 604 until hook 644 engages teeth 616 of ring gear 202. In some embodiments, torsional spring 638 is configured to bias release linkage 640 to translate into the disengaged state (shown in FIG. 6). For example, torsional spring 638 can be pivotally coupled at a first end with first frame member 40 through an aperture 636 and pivotally coupled with release linkage 640 at a second or distal end. Torsional spring 638 may bias release linkage 640 into the disengaged state (shown in FIG. 6), thereby biasing lever 38 into the first position at the upper end of slots 646-648.

In some embodiments, hook 644 is configured to engage teeth 616 such that ring gear 202 is prevented from rotating in a first direction (e.g., in a direction opposite direction 24) but is free to rotate in a second direction (e.g., in direction 24). When lever 38 is transitioned between the first position at the upper end of slots 646-648 and the second position at the lower end of slots 646-648, second gear 606 may maintain meshing or engagement with second sub-gear 612. For example, second gear 606 may translate relative to second sub-gear 612 along an arc path centered at axis 622 of compound gear 608, thereby maintaining engagement between teeth 660 of second gear 606 and teeth 620 of second sub-gear 612.

In some embodiments, transitioning or translating lever 38 into the second position at the bottom or lower end of slots 646-648 rotatably fixedly couples input shaft 32 from spool 20 and ring gear 202 or rotatably de-couples input shaft 32 from spool 20. In this way, a user may operate lever 38 to simultaneously or concurrently transition guide member 900 between the let-out position and the take-up position, while selectively de-coupling or rotatably fixedly coupling input shaft 32 with spool 20 (e.g., for take-up or let-out operations of reel 12).

### Spool Drive Mechanism

### Spool Engagement Mechanism

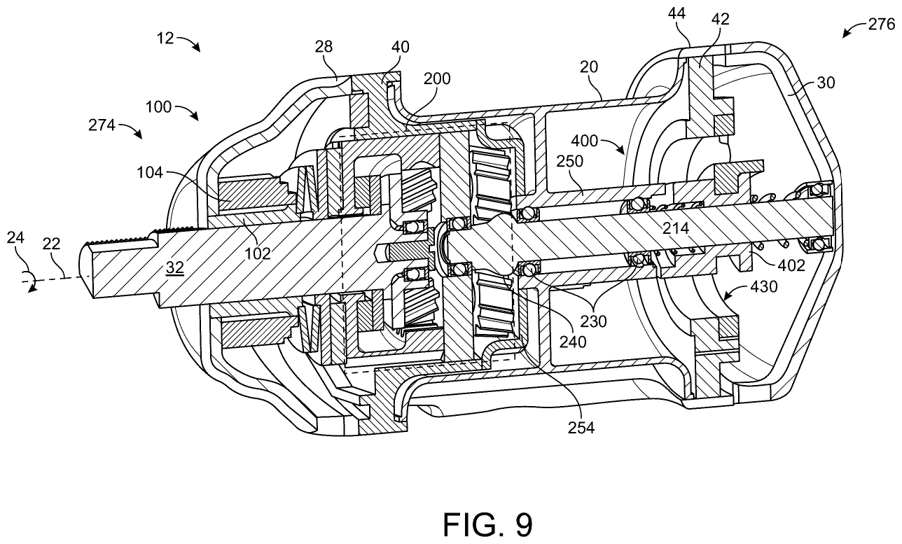

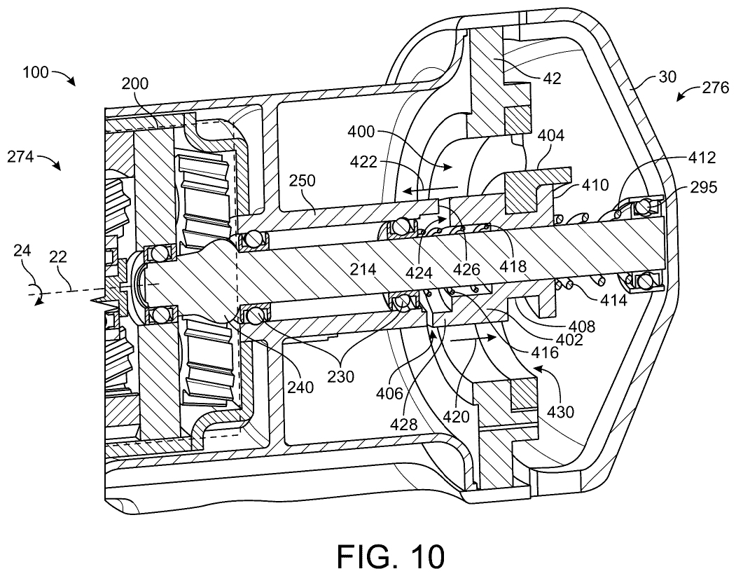

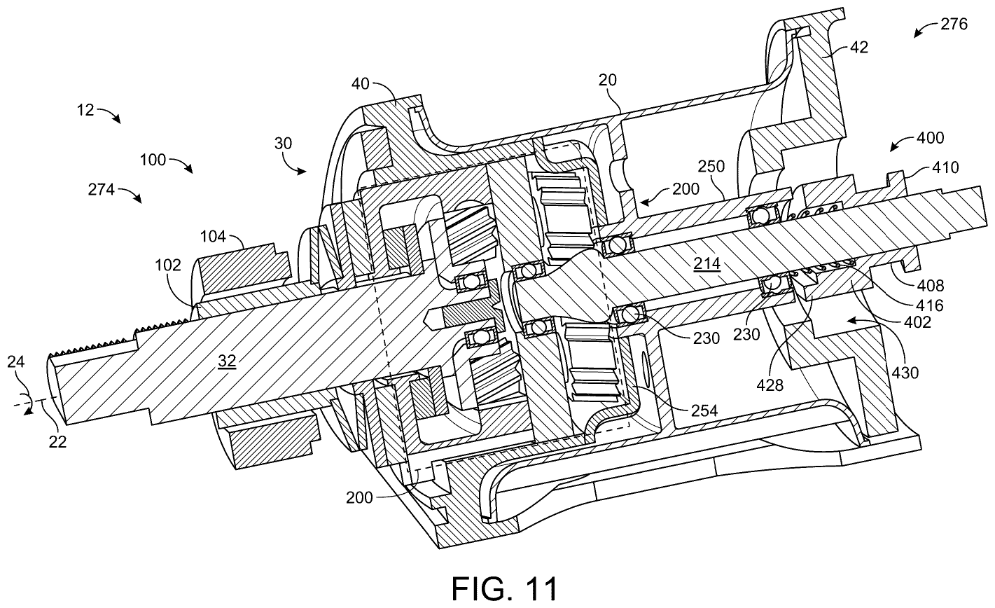

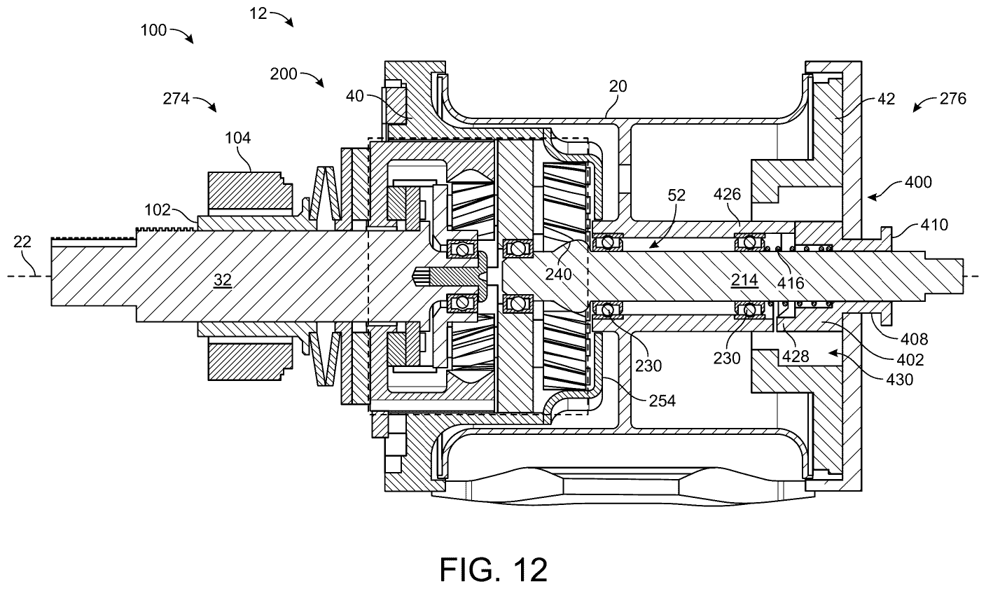

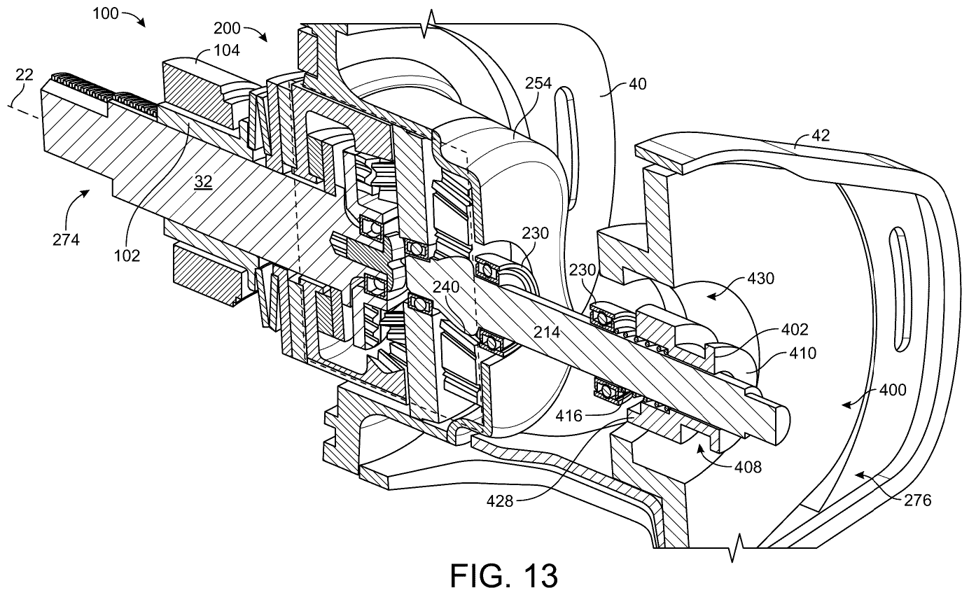

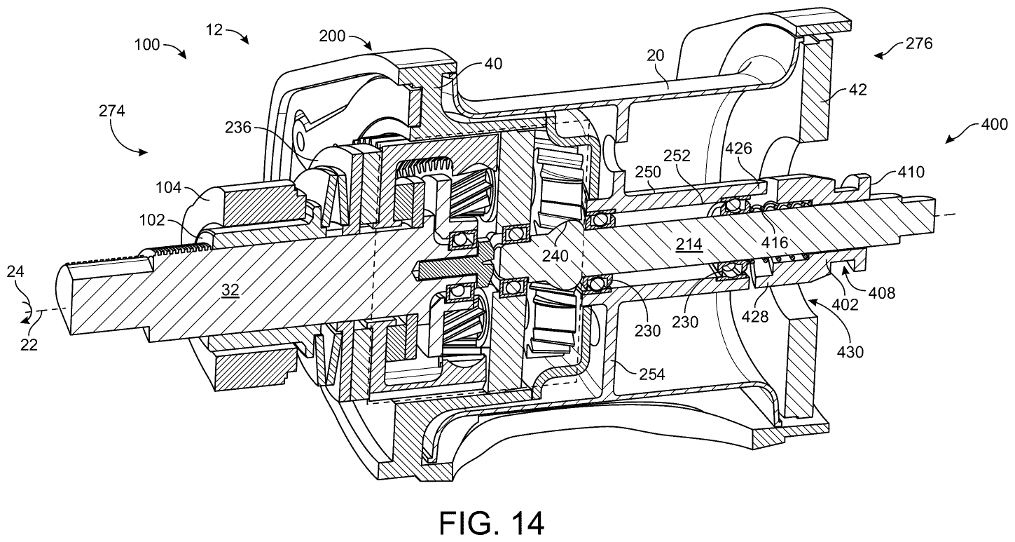

Referring particularly to FIGS. 9-14, spool drive mechanism 100 includes a gear set 200, a collar 102, and a one-way bearing, clutch, sprag bearing, sprag clutch, etc., shown as one-way bearing 104. Gear set 200 is positioned at least partially within an inner volume of spool 20 and within an inner volume defined by an inner body member 254, body member 44, and first body member 28. Gear set 200 can be a planetary gear set or any other gear train, gear box, or gear configuration that is configured to receive input torque or rotational kinetic energy from input shaft 32. Gear set 200 is configured to receive the input torque or the rotational kinetic energy from input shaft 32 and transfer the input torque to an output shaft 214.

Output shaft 214 may extend through an inner volume of spool 20 defined by a central member, a cylindrical member, a central sleeve, etc., of spool 20, shown as spool shaft 250. Spool shaft 250 is rotatably coupled with spool shaft 250 through one or more bearings, ball bearings, roller bearings, etc., shown as spool bearings 230. A radially outwards facing surface of an outer race of spool bearings 230 is rotatably fixedly coupled (e.g., press fit, keyed, slip fit, etc.) with a radially inwards facing surface of spool shaft 250. A radially inwards facing surface of an inner race of spool bearings 230 is rotatably fixedly coupled with a radially outwards facing surface of output shaft 214. In some embodiments, the output shaft 214 is configured to selectably rotate freely relative to spool 20. For example, spool 20 and output shaft 214 may be configured to rotate freely relative to each other when reel 12 is transitioned into a let-out state. In some embodiments, spool 20 and output shaft 214 are configured to rotate in unison when reel 12 is transitioned into a take-out state.

Referring still to FIGS. 9-14, spool drive mechanism 100 includes a spool engagement mechanism 400, according to an exemplary embodiment. Spool engagement mechanism 400 is configured to transition between a first state (e.g., a take-up state) to rotatably fixedly couple spool 20 with output shaft 214 and a second state (e.g., a let-out state) to de-couple spool 20 and output shaft 214. Spool engagement mechanism 400 includes a first member, an engagement member, a spool shaft engagement member, a collar, etc., shown as engagement member 402. Engagement member 402 includes an inner volume, a central aperture, a through-hole, etc., shown as central volume 414 through which output shaft 214 extends. Output shaft 214 and engagement member 402 may extend through an aperture, an inner volume, a hole, a bore, a window, an opening, etc., of second frame member 42, shown as opening 430.

Output shaft 214 is configured to engage, interface with, etc., one or more output gears of gear set 200 at a first or proximate end. Output shaft 214 is supported and rotatably coupled at a second or distal end with second body member 30. Output shaft 214 can be supported at the second or distal end with second body member 30 through a bearing 295. The first or proximate end of output shaft 214 can include teeth 240 that are configured to engage corresponding gears, teeth, etc., of gear set 200.

Engagement member 402 is configured to slidably couple with output shaft 214 such that engagement member 402 can translate along output shaft 214. In some embodiments, engagement member 402 is rotatably fixedly coupled with output shaft 214 (e.g., through a spline coupling, a spline connection, a keyed connection, etc.) so that engagement member 402 is configured to rotate in unison with rotation of output shaft 214. In this way, engagement member 402 may be free to translate along output shaft 214 in a longitudinal direction defined by axis 22, while being rotatably fixedly coupled with output shaft 214.

Spool engagement mechanism 400 includes an adjustment member, a linkage, a bar, an elongated member, etc., shown as linkage 404. Linkage 404 is configured to drive engagement member 402 to translate along output shaft 214. In some embodiments, linkage 404 is configured to drive engagement member 402 to translate between a first longitudinal position on output shaft 214 and a second longitudinal position on output shaft 214.

Engagement member 402 includes an outwards facing surface, an exterior face, a contact surface, an engagement surface, etc., shown as engagement surface 410. A spring (e.g., a compression spring), shown as first spring 412 is positioned between engagement member 402 and bearing 295 and is configured to engage, contact, abut, etc., engagement surface 410 of engagement member 402 and bearing 295. First spring 412 may be configured to bias or drive engagement member 402 to translate along output shaft 214 in direction 422. Engagement member 402 also includes a bore, a blind hole, an aperture, etc., that extends into a side of engagement member 402 that is opposite engagement surface 410. The blind hole may have a diameter that is larger than a diameter of central volume 414, thereby defining a shoulder or a step 418 at a transition between central volume 414 and the blind hole.

Spool engagement mechanism 400 can include a second spring 416 (e.g., a compression spring) that is configured to engage, abut, contact, etc., step 418 of engagement member 402 at a first end, and engage, abut, contact, etc., one of spool bearings 230 at a second or opposite end. Second spring 416 can be configured to bias or drive engagement member 402 to translate along output shaft 214 in a direction 420 that is opposite direction 422. In this way, first spring 412 is configured to drive or bias engagement member 402 to translate in direction 422, while second spring 416 is configured to drive or bias engagement member 402 to translate in direction 420. In some embodiments, second spring 416 has a stiffness that is less than a stiffness of first spring 412.

Engagement member 402 includes an inwards end 424 that is opposite engagement surface 410. Spool shaft 250 includes an outwards end 406 that is proximate inwards end 424 of engagement member 402. Outwards end 406 of spool shaft 250 may include an interfacing portion 426 that is configured to interlock with a corresponding interfacing portion 428 of engagement member 402. For example, interfacing portion 426 of spool shaft 250 and interfacing portion 428 of engagement member 402 can be teeth or longitudinal protrusions that are configured to interlock with each other when engagement member 402 is transitioned into the first longitudinal position. When engagement member 402 is transitioned into the first longitudinal position along output shaft 214, interfacing portion 428 of engagement member 402 interlocks with, or rotatably fixedly couples with interfacing portion 426 of spool shaft 250. When engagement member 402 is transitioned into the second longitudinal position along output shaft 214, interfacing portion 426 of spool shaft 250 and interfacing portion 428 of engagement member 402 are de-coupled from each other such that spool shaft 250 and output shaft 214 are free to rotate relative to each other. In some embodiments, when engagement member 402 is transitioned or translated to the first longitudinal position along output shaft 214 such that engagement member 402 and spool shaft 250 are interlocked, spool bearings 230 rotate in unison with spool shaft 250, spool 20, and engagement member 402.

In some embodiments, engagement member 402 includes an annular groove 408. Annular groove 408 is configured to receive a correspondingly shaped portion of linkage 404 therewithin. Linkage 404 can be driven to translate or rotate by lever 38. For example, when lever 38 is pressed or translated to a first position (e.g., downwards), linkage 404 drives engagement member 402 to translate along output shaft 214 (e.g., in direction 420 or in direction 422) between the first longitudinal position and the second longitudinal position along output shaft 214. In some embodiments, pressing, moving, or rotating lever 38 downwards into the first position drives linkage 404 to translate in direction 420 to an engaged position (i.e., the first longitudinal position), while lifting, moving, or rotating lever 38 upwards into the second position drives linkage 404 to translate in direction 422 to a disengaged position (i.e., the second longitudinal position). In other embodiments, pressing, moving, or rotating lever 38 downwards into the first position drives linkage 404 to translate in direction 422 to the disengaged position (i.e., the second longitudinal position), while lifting, moving, or rotating lever 38 upwards into the second position drives linkage 404 to translate in direction 420 to the engaged position (i.e., the first longitudinal position).

Referring still to FIGS. 9-14, input shaft 32 can be driven by spinning handle 36 in direction 24. Input shaft 32 receives rotational kinetic energy or torque from a first end, a proximate end, a handle end, etc., of reel 12, shown as handle end 274. Handle end 274 may be a side, portion, or end of reel 12 that is proximate handle 36. In some embodiments, input shaft 32 receives the torque input from an end of reel 12 that is proximate first body member 28 or first frame member 40. The torque input that is received by input shaft 32 is transferred through gear set 200 to spool 20. The torque may be increased or decreased across gear set 200 before it is provided to spool 20 to drive spool 20 for taking-up or reeling fishing line 26.

The torque may be provided to spool 20 at a second end, a second side, a distal end, a distal portion, etc., of reel 12, shown as distal end 276. The torque may be provided to spool 20 to drive spool 20 through the engagement between spool shaft 250 and engagement member 402. In some embodiments, the torque is provided to spool 20 at spool shaft 250 by selectably rotatably fixedly coupling spool 20 and output shaft 214 (e.g., by transitioning engagement member 402 into the first longitudinal position) and driving output shaft 214, thereby driving spool shaft 250 and spool 20. In some embodiments, distal end 276 is a side or end of reel 12 that is opposite handle end 274. For example, spool 20 may receive input torque from output shaft 214 through engagement member 402 at an end, side, or portion, of reel 12 that is proximate second body member 30, second frame member 42, etc. In this way, input torque is provided to input shaft 32 from a first end or a first side of reel 12 (i.e., handle end 274), while spool 20 is driven to rotate about axis 22 from a second end or distal side of reel 12 (i.e., distal end 276).

Advantageously, driving spool 20 from an end, side, or portion of reel 12 that is opposite handle end 274 facilitates an evenly weighted reel 12. For example, a weight of handle 36 may be countered or balanced by a weight of engagement member 402. In some embodiments, moments produced by handle 36 counter, equal, or balance with moments produced by engagement member 402.

### Plunger Sub-Assembly

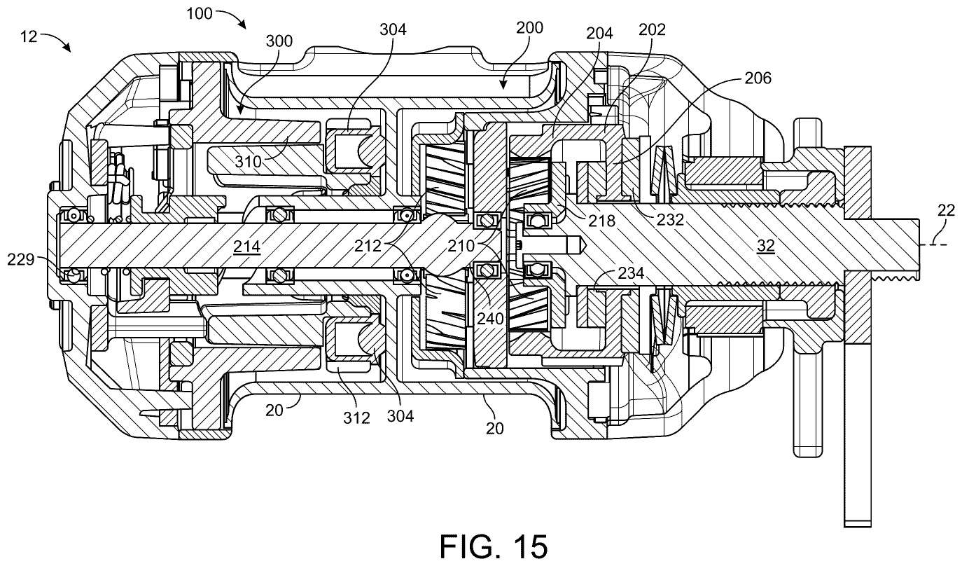

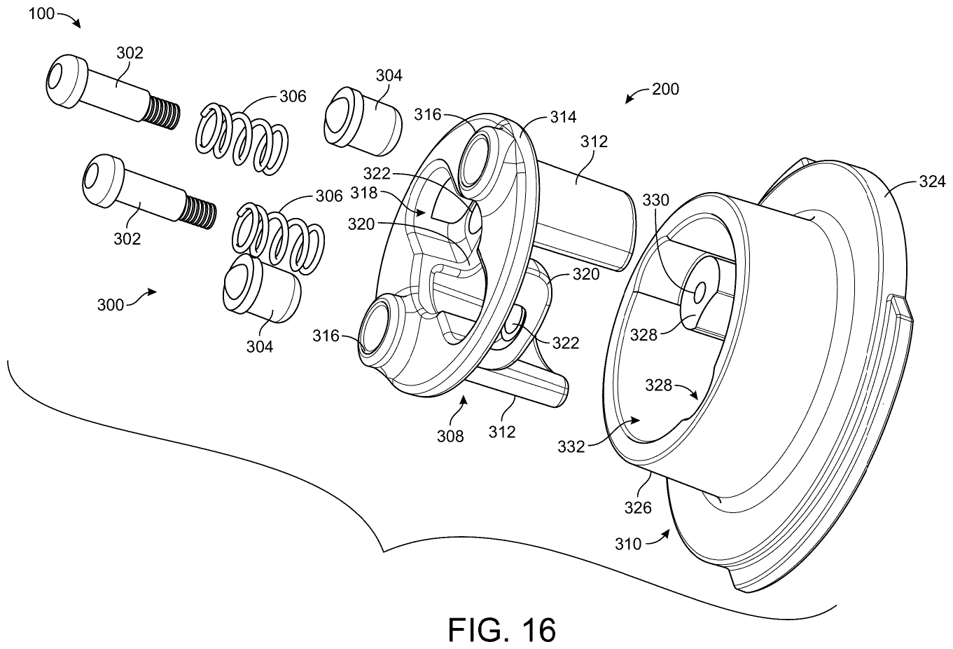

Referring particularly to FIGS. 15 and 16, reel 12 or spool drive mechanism 100 can include a plunger sub-assembly 300. Plunger sub-assembly 300 may be centered about axis 22. Plunger sub-assembly 300 may be positioned at least partially within spool 20. In some embodiments, plunger sub-assembly 300 includes a flange member, a receiving member, etc., shown as flange member 310. Plunger sub-assembly 300 can also include an intermediate member, a rotatable member, etc., shown as intermediate member 308. In some embodiments, flange member 310 includes a central aperture, a central volume, a bore, etc., shown as central volume 332. Central volume 332 is configured to receive a corresponding portion of intermediate member 308 therewithin. In some embodiments, flange member 310 and intermediate member 308 slidably or rotatably couple with each other such that intermediate member 308 can rotate relative to flange member 310.

Central volume 332 can have a cross-sectional shape that corresponds to an outer periphery of intermediate member 308. In some embodiments, flange member 310 includes a first portion, a radial protrusion portion, an annular protrusion, etc., shown as annular protrusion 324. Flange member 310 can include a cylindrical portion, a longitudinally extending portion, a second portion, etc., shown as longitudinally extending portion 326. Longitudinally extending portion 326 may extend from and be integrally formed with annular protrusion 324. Longitudinally extending portion 326 may extend longitudinally along axis 22 while annular protrusion 324 extends outwards from longitudinally extending portion 326 in a radially outwards direction.

Longitudinally extending portion 326 may define central volume 332 and can include one or more interfacing portions, coupling portions, etc., shown as interfacing portions 328. In some embodiments, interfacing portions 328 are positioned along an inner surface of longitudinally extending portion 326, or along an inner surface of central volume 332 (e.g., along a radially inwards facing surface). Interfacing portions 328 may be stepped cylindrical portions that are integrally formed with longitudinally extending portion 326 or with flange member 310 at the radially inwards facing surface defined by central volume 332. Interfacing portions 328 may each include an aperture, a bore, a blind hole, an inner volume, etc., shown as receiving aperture 330. In some embodiments, receiving apertures 330 are each configured to receive a corresponding fastener therethrough and facilitate removable fixed coupling between intermediate member 308 and flange ember 310.

Plunger sub-assembly 300 also includes several fasteners 302, several cylindrical or pin members 304, and several springs or tensile members, shown as springs 306. In some embodiments, springs 306 are compression springs that are configured to exert an expansive force when compressed. Fasteners 302 may extend through springs 306 and may fixedly couple (e.g., threadingly couple) with interfacing portions 328 through receiving apertures 330. In some embodiments, intermediate member 308 includes longitudinally extending tabs, protrusions, etc., shown as tabs 312 that include a radially outwards facing surface configured to slidably couple or frictionally interface with a corresponding radially inwards facing surface defined by central volume 332.

Intermediate member 308 includes receiving bores, blind holes, etc., shown as bores 316. In some embodiments, a number of bores 316 is equal to a number of pin members 304. Pin members 304 can be received within bores 316 and slidably couple with intermediate member 308 such that pin members 304 can slide within bores 316. In some embodiments, pin members 304 are configured to engage, directly contact, etc., a corresponding portion of spool 20. In some embodiments, pin members 304 include a step or an annular protrusion to facilitate preventing complete insertion of pin members 304 into bores 316.

Intermediate member 308 includes a central volume, a central aperture, a window, an opening, etc., shown as central window 318. In some embodiments, central window 318 has the shape of a slot. Intermediate member 308 can include engagement portions 320 that each include a bore, a through-hole, etc., shown as through-holes 322 configured to align and receive fasteners 302 therethrough. In some embodiments, through-holes 322 have a diameter that is substantially equal to or greater than an outer diameter of fasteners 302 but is less than springs 306. In this way, springs 306 can be positioned between a stepped end of fasteners 302 and engagement portions 320. Tabs 312 can have an outer periphery or an outer shape that corresponds to an inner periphery or an inner shape of central volume 332 so that tabs 312 are received within central volume 332.

### Spool Drive Mechanism

### Compound Planetary Gear Set

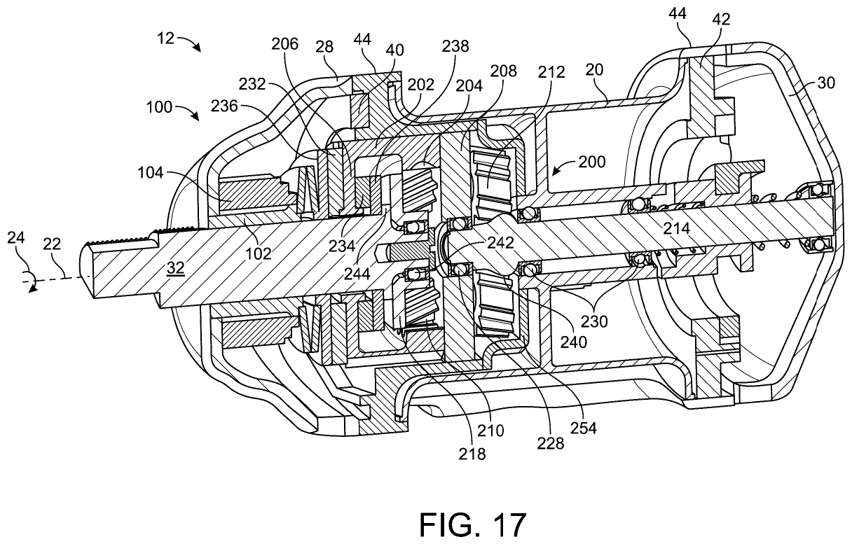

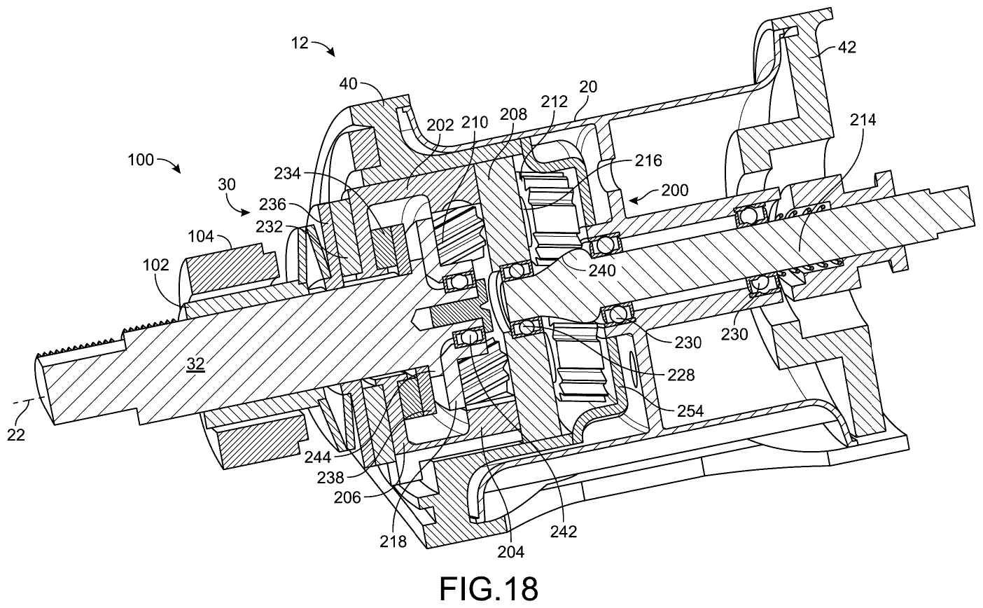

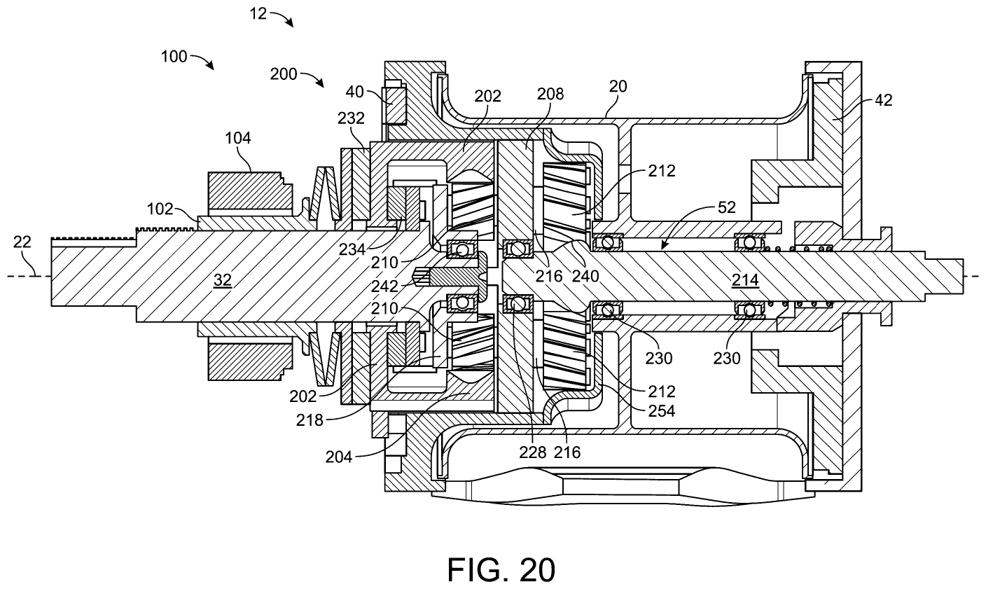

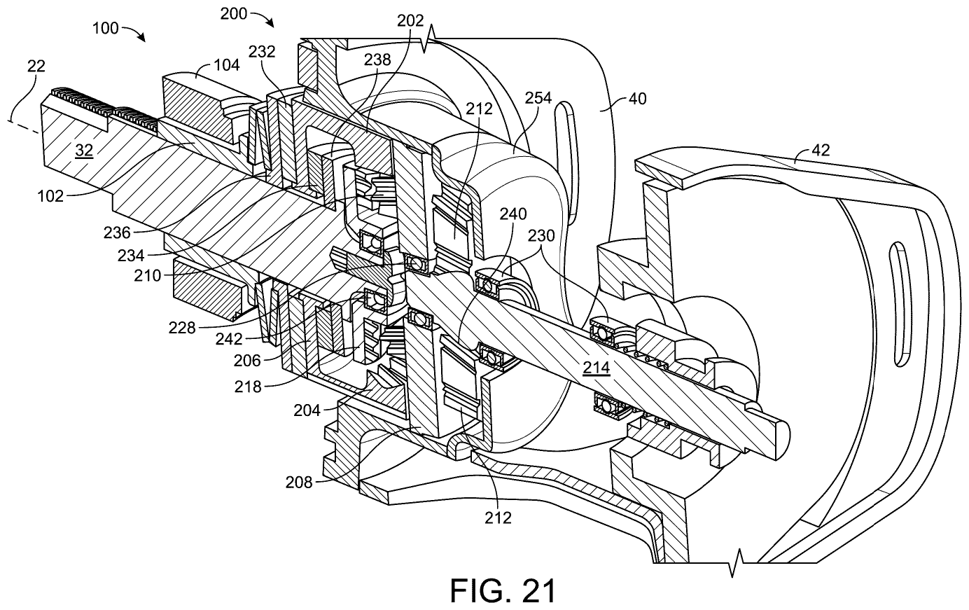

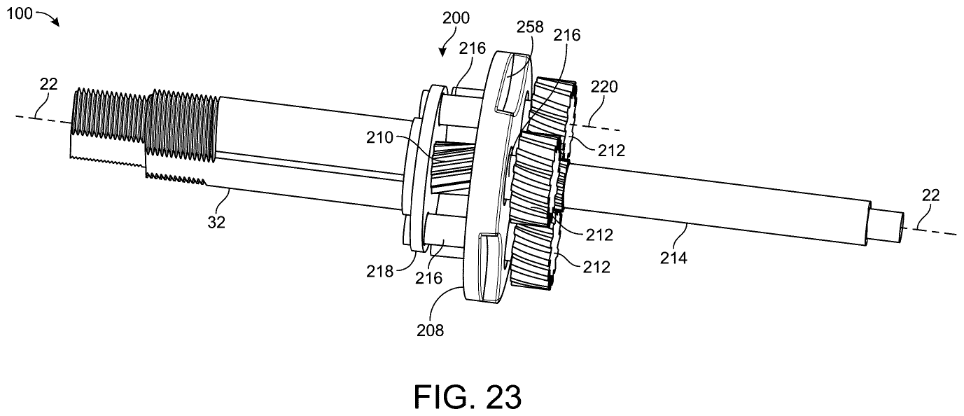

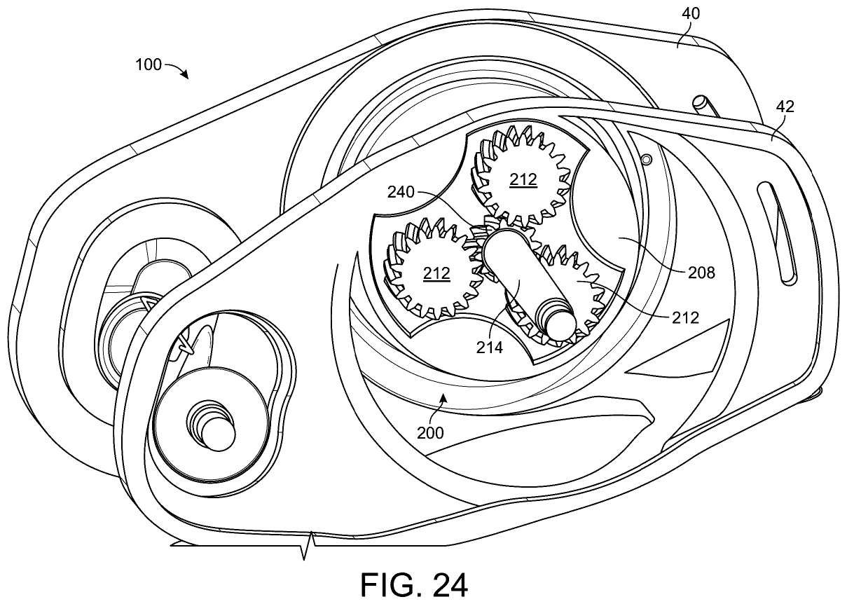

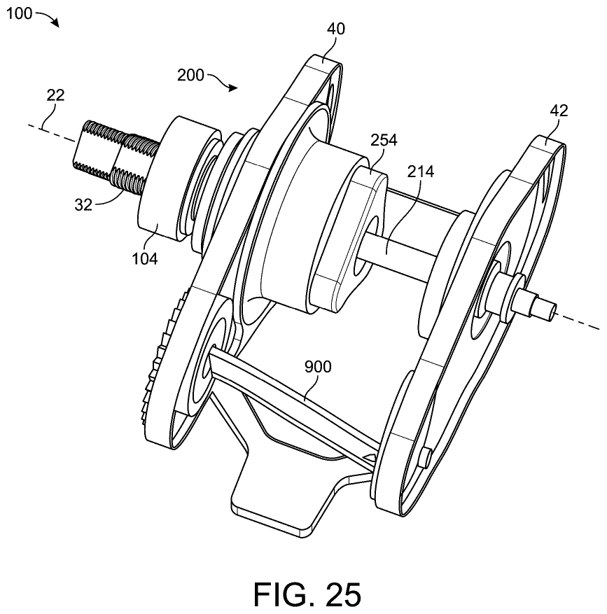

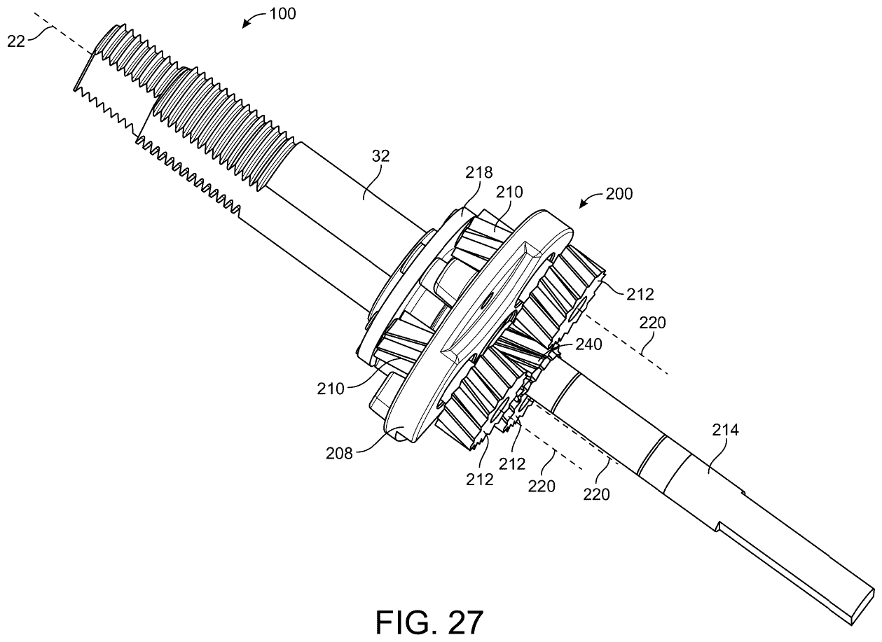

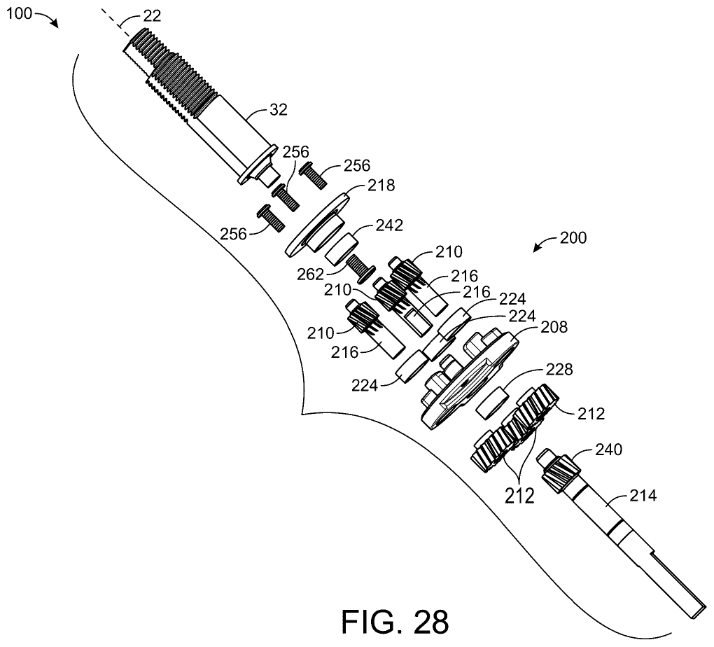

Referring particularly to FIGS. 17-28, spool drive mechanism 100 includes a planetary gear set, a planetary gear train, a compound planetary gear set, etc., shown as compound gear set 200. Compound gear set 200 may include input shaft 32 or may be driven by input shaft 32. For example, turning input shaft 32 may drive compound gear set 200 of spool drive mechanism 100, thereby driving rotation of spool 20.

Reel 12 also includes a second structural member, a left structural member, a frame member, etc., shown as second structural member 42. First structural member 40 and second structural member 42 can be parallel with each other and may be positioned apart. Input shaft 32 may extend through first structural member 40. In some embodiments, first body member 28 and second body member 30 are fixedly coupled with first structural member 40 and second structural member 42.

Referring particularly to FIGS. 1, 20-23, and 27-28, compound gear set 200 includes a ring member 202 that is configured to be driven to rotate by turning of input shaft 32. Ring member 202 can be centered or co-axial with axis 22 can may be configured to rotate about axis 22. Ring member 202 can include a ring gear portion 204 and an engagement portion 206. In some embodiments, ring gear portion 204 includes radially inwards facing teeth that are configured to engage or mesh with corresponding teeth, gears, planet gears, etc., of compound gear set 200. Engagement portion 206 can be selectably or adjustably fixedly coupled with input shaft 32. For example, engagement portion 206 may be fixedly rotatably coupled with input shaft 32 through a frictional interface. The frictional interface may be adjustable (e.g., by a user input, by twisting a knob, etc.) to increase or decrease a strength of the frictional interface.

Compound gear set 200 also includes a carrier 208, multiple planet gear shafts 216, input planet gears 210 (e.g., first planet gears), output planet gears 212 (e.g., second planet gears), and an output shaft 214. In some embodiments, ring member 202 includes radially inwards facing teeth that are configured to engage input planet gears 210. Input planet gears 210 are each rotatably or fixedly coupled with a corresponding one of planet gear shafts 216. Planet gear shafts 216 may each extend through and rotatably couple with an inner race of a corresponding planet gear bearing 224. An outer race of planet gear bearings 224 is fixedly coupled with carrier 208. For example, planet gear bearings 224 may be press fit into an aperture, an opening, a hole, a bore, etc., of carrier 208, shown as aperture 226. Carrier 208 can include multiple apertures 226 that are positioned a radial distance away from axis 22 and are evenly angularly spaced about axis 22. For example, compound gear set 200 can include three sets of a planet gear bearing 224, an input planet gear 210, an output planet gear 212, and a planet gear shaft 216. Output planet gears 212 may be positioned within an inner housing member, an inner shell member, an inner body member, etc., shown as inner body member 254. Inner body member 254 can extend between opposite portions of body member 44.

Planet gear bearings 224 are press fit, slip fit, or otherwise fixedly coupled along an outer race with apertures 226 (or an inner surface of carrier 208 that is defined by apertures 226). Planet gear shafts 216, input planet gears 210, and output planet gears 212 can be rotatably coupled with carrier 208 through planet gear bearings 224 so that planet gear shafts 216, input planet gears 210, and output planet gears 212 can spin relative to carrier 208 about their respective axes 220 (shown in FIG. 5). Planet gear shaft 216, input planet gear 210, and output planet gear 212 may be fixedly or rotatably coupled with each other (e.g., integrally formed) so that each set of planet gear shaft 216, input planet gear 210, and output planet gear 212 spin in unison about its respective axis 220. Axis 220 extends through each planet gear shaft 216, input planet gear 210, and output planet gear 212 and may be radially offset from axis 22 of input shaft 32. Planet gear shaft 216 is supported or rotatably coupled at a first end by a flange member 218 of compound gear set 200.

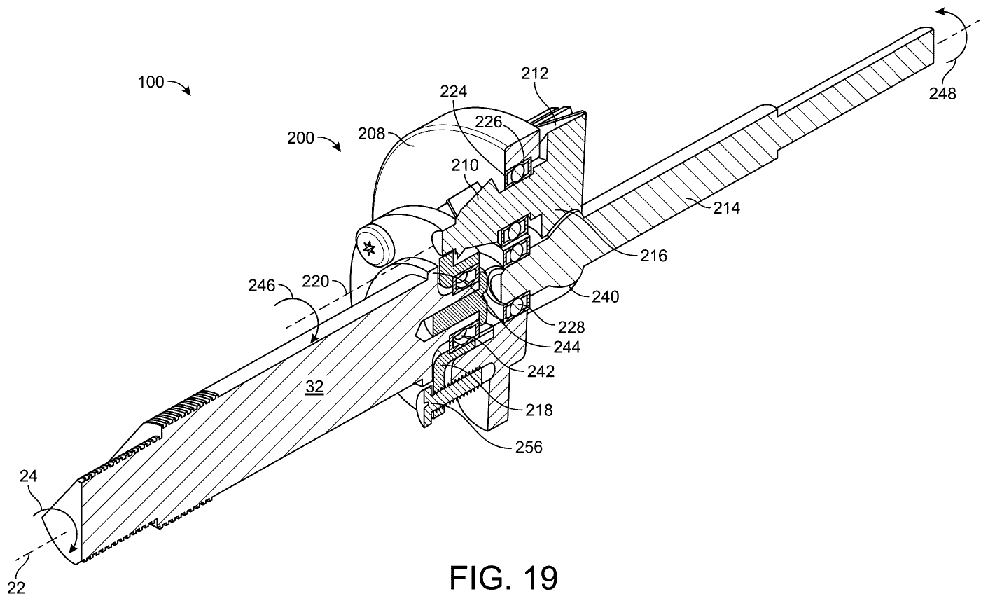

As shown in FIG. 19, carrier 208 can be bolted or otherwise fixedly coupled with flange member 218 (e.g., a retaining member) through fasteners 256 or fixedly coupled with any other retaining member. In some embodiments, carrier 208 is press fit into first structural member 40. The retaining member may include an aperture, a hole, an inner volume, recesses (e.g., recesses 258 shown in FIG. 9), etc., configured to receive a push-shaft for pressing carrier 208 into first structural member 40 and to prevent tipping of central bearing 228.

Input shaft 32 includes a first or proximate end where handle 36 is coupled with input shaft 32, and a second or distal end that is opposite the first end. Flange member 218 is rotatably coupled with input shaft 32 at the second or distal end. Flange member 218 is co-axial with axis 22 and may be free to rotate relative to input shaft 32. Flange member 218 may be configured to rotatably couple with the second end of input shaft 32 through input shaft bearing 242. Input shaft bearing 242 can include an inner race and an outer race. The outer race of input shaft bearing 242 can be fixedly coupled with a corresponding radially inwards facing surface of flange member 218. The inner race of input shaft bearing 242 can be fixedly coupled with a corresponding radially outwards facing surface of input shaft 32 at the second end of input shaft 32.

Flange member 218 is configured to rotatably couple with an end of planet gear shafts 216. In some embodiments, an end portion of planet gear shafts 216 or a protrusion of input planet gears 210 extends through a corresponding aperture of flange member 218. In this way, planet gear shafts 216 and/or input planet gears 210 may rotatably couple with flange member 218. In some embodiments, planet gear shafts 216 and input planet gears 210 are free to rotate about their axis 220 relative to flange member 218.

Input shaft 32 is configured to drive ring member 202 which engages and drives input planet gears 210. Input shaft 32 may rotate about axis 22, thereby driving ring member 202 to rotate about axis 22. Rotation of ring member 202 about axis 22 drives each set of input planet gear 210, planet gear shaft 216, and output planet gear 212 to spin about their respective axes 58. Input planet gears 210, planet gear shafts 216, and output planet gears 212 may each be driven to spin about their respective axes 220 by the engagement between teeth of input planet gears 210 and radially inwards facing teeth of ring member 202. In some embodiments, input planet gears 210, planet gear shafts 216, and output planet gears 212 spin about their respective axes 220 without orbiting about axis 22. For example, axes 220 may be translationally fixed relative to carrier 208 so that each assembly of input planet gear 210, planet gear shaft 216, and output planet gear 212 spin about axis 220 while axis 220 remains stationary.

Carrier 208 can be fixedly coupled with first structural member 40, first body member 28, or any other stationary structural or housing component of reel 12. Spinning of planet gear shafts 216 and input planet gears 210 about their respective axes 220 drives rotation of output planet gears 212 which engage, mesh, or otherwise interface with teeth 240 of output shaft 214. In some embodiments, output planet gears 212 have a larger number of teeth with respect to input planet gears 210 such that rotation of input shaft 32 at a first speed results in rotation of output shaft 214 at a second speed that is higher than the first speed. Output shaft 214 can be rotatably coupled with carrier 208 through a central bearing 228. For example, a radially outwards facing surface of output shaft 214 may be fixedly coupled with a radially inwards facing surface of an inner race of central bearing 228. A radially outwards facing surface of an outer race of central bearing 228 can be fixedly coupled (e.g., press fit, interference fit, slip fit, etc.) with a radially inwards facing surface of carrier 208.

In this way, turning input shaft 32 (e.g., by rotating handle 36) drives rotation of output shaft 214. Output shaft 214 can be fixedly coupled with spool 20 such that rotation of output shaft 214 about axis 22 drives rotation of spool 20 about axis 22. In some embodiments, output shaft 214 is selectably fixedly coupled with spool 20. Spool 20 can include an inner volume 52 through which output shaft 214 extends. In some embodiments, spool 20 and output shaft 214 are rotatably coupled with each other through spool bearings 230. A radially outwards facing surface of an outer race of spool bearings 230 is fixedly coupled or otherwise coupled with a radially inwards facing surface of spool 20. A radially inwards facing surface of an inner race of spool bearings 230 is fixedly coupled (e.g., press fit, keyed, etc.) with a radially outwards facing surface of output shaft 214.

Spool 20 can include a central member, a cylindrical member, a central sleeve, etc., shown as spool shaft 250. Spool shaft 250 may be a hollow cylindrical member that is integrally formed with spool 20. Spool shaft 250 includes a radially inwards facing surface 252 and may extend longitudinally along axis 22. Surface 252 may engage, abut, interface with, fixedly couple with, etc., a radially outwards facing surface of the outer race of spool bearings 230.

Ring member 202 may be fixedly rotatably coupled with input shaft 32 through a first frictional member 232 and a second frictional member 234. First frictional member 232 and second frictional member 234 are configured to engage, abut, contact, etc., opposite sides of engagement portion 206 of ring member 202 to fixedly couple ring member 202 with input shaft 32. First frictional member 232 may abut, contact, engage, etc., a first annular member, a first engagement member, a connecting member, etc., shown as first engagement member 236. Second frictional member 234 may abut, contact, engage, etc., a second annular member, a second engagement member, a connecting member, etc., shown as second engagement member 238. First engagement member 236 and second engagement member 238 may be rotatably fixedly coupled with input shaft 32 (e.g., through a keyed interface, a spline connection, flats that interface with input shaft 32, etc).

As input shaft 32 is turned (e.g., by the fisherman's hand), rotational kinetic energy is transferred from input shaft 32 to ring member 202 through the frictional engagement between frictional members 232 and 234 and engagement portion 206 of ring member 202. Ring member 202 then rotates with input shaft 32 and drives input planet gears 210 to spin. Input planet gears 210 spin about their respective axes 220, thereby driving planet gear shaft 216 to spin and driving output planet gear 212 to spin. Output planet gears 212 engage teeth 240 of output shaft 214 so that spinning of output planet gears 212 drives rotation of output shaft 214.

Referring particularly to FIGS. 17-19, input shaft 32 can include a step, a shoulder, an annular protrusion, etc., shown as annular protrusion 244. Annular protrusion 244 is configured to engage second engagement member 238.

Referring particularly to FIGS. 17-22, spool drive mechanism 100 can include a collar, a sleeve, an annular member, etc., shown as collar 102. Spool drive mechanism 100 can also include a one-way bearing, a sprag clutch, a sprag bearing, a trapped bearing, etc., shown as one-way bearing 104. One-way bearing 104 may facilitate or allow rotation of input shaft 32 in direction 24 about axis 22 but prevent, restrict, or facilitate preventing rotation of input shaft 32 about axis 22 in a direction opposite direction 24.

One-way bearing 104 can be rotatably coupled with collar 102 so that one-way bearing 104 is supported by collar 102 on input shaft 32. Collar 102 may be rotatably fixedly coupled with input shaft 32 (e.g., keyed) such that collar 102 rotates or turns with input shaft 32. In some embodiments, one-way bearing 104 is fixedly rotatably coupled with first body member 28 so that first body member 28 can provide reactionary force to input shaft 32 through one-way bearing 104 and collar 102 to prevent or facilitate preventing turning input shaft 32 in a direction opposite direction 24.

When input shaft 32 is turned in direction 24, input shaft 32 drives ring member 202 which spins input planet gears 210 about their respective axes 220. Input planet gears 210 drive planet gear shafts 216 and output planet gears 212 to spin about axes 220. Output planet gears 212 then drive output shaft 214 to rotate about axis 22. One-way bearing 104 may allow turning of input shaft 32 in direction 24. Turning input shaft 32 in direction 24 drives input planet gears 210, planet gear shafts 216, and output planet gears 212 to spin about their respective axes 220 in direction 246. Spinning of input planet gears 210, planet gear shafts 216, and output planet gears 212 about axes 220 in direction 246 drives rotation of output shaft 214 in direction 248 about axis 22. Spool 20 may be rotatably fixedly coupled with output shaft 214 so that spool 20 rotates in direction 248 about axis 22 in unison with rotation of output shaft 214. In some embodiments, spool 20 and output shaft 214 rotate in direction 248 so that fishing line 26 is taken up or wound onto spool 20.

Spool 20 and output shaft 214 may be prevented from rotating in a direction about axis 22 that is opposite direction 248. If spool 20 and output shaft 214 are driven to rotate in a direction that is opposite direction 248, torque may be transferred through spool 20, output shaft 214, output planet gears 212, planet gear shafts 216, input planet gears 210, ring member 202, and input shaft 32. One-way bearing 104 may prevent rotation of back-driving of spool 20 and output shaft 214. In some embodiments, spool 20 and output shaft 214 are selectably coupled such that spool 20 may be free to rotate relative to output shaft 214 (e.g., during let-out of fishing line 26), thereby de-coupling spool 20 from one-way bearing 104.

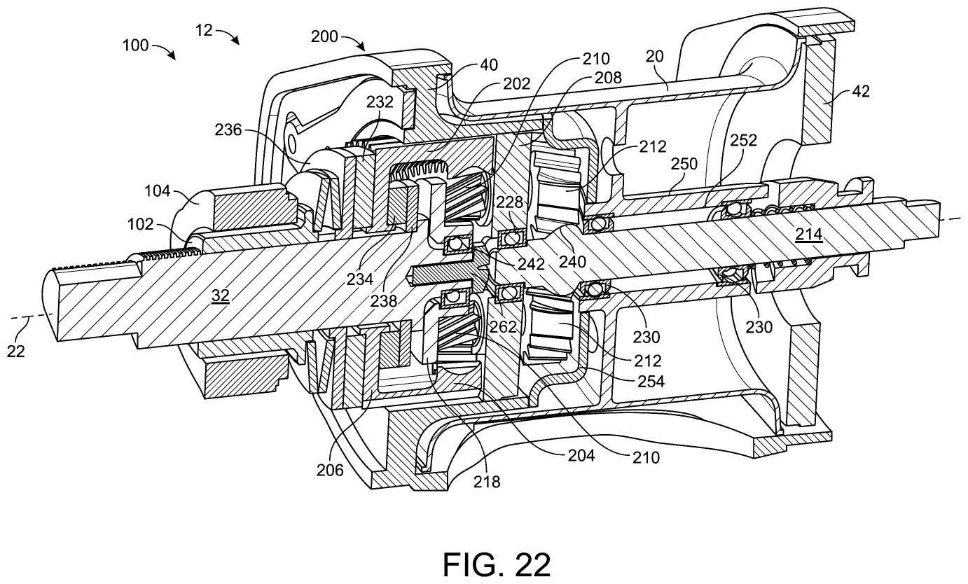

Referring particularly to FIGS. 22 and 27-28, flange member 218 can be rotatably coupled with carrier 208 through fasteners 256 that extend through flange member 218. In some embodiments, three fasteners 256 are used to translationally and/or rotatably fixedly couple flange member 218 with carrier 208. In some embodiments, flange member 218 is fixedly coupled (e.g., rotatably and/or translationally) with input shaft 32 through a fastener 262 that extends through a central portion (e.g., a central aperture, a through hole, etc.) of flange member 218 and threadingly couples with input shaft 32.

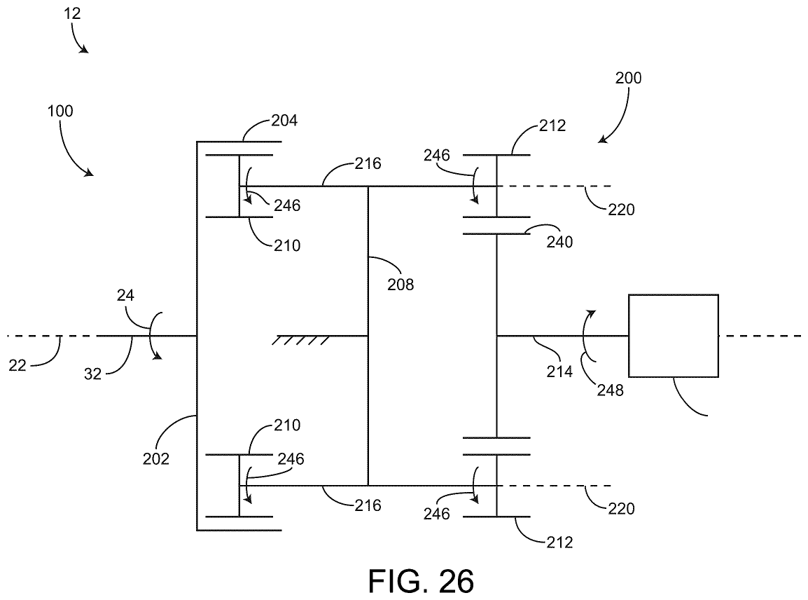

Referring particularly to FIG. 26, a schematic diagram of compound gear set 200 is shown, according to an exemplary embodiment. Compound gear set 200 receives rotational kinetic energy from input shaft 32 (e.g., in direction 24) and transfers the rotational kinetic energy to input planet gears 210 such that input planet gears 210 spin about their respective axes 220 in direction 246. Compound gear set 200 may transfer the rotational kinetic energy from input shaft 32 to input planet gears 210 to spin input planet gears 210 about axes 220 in direction 246. Input planet gears 210 can rotate about axis 220 while being fixedly coupled with carrier 208. Carrier 208 is fixedly rotatably coupled such that axes 220 do not rotate relative to axis 22 (e.g., such that input planet gears 210, planet gear shafts 216, and output planet gears 212 do not orbit axis 22). Input planet gears 210, planet gear shafts 216, and output planet gears 212 rotate or spin about axes 220 and drive output shaft 214 through the interface or engagement between output planet gears 212 and teeth 240 of output shaft 214. Output shaft 214 may be rotatably fixedly coupled with spool 20 so that spool 20 rotates about axis 22. Spool 20, output shaft 214, and input shaft 32 may all be co-axial with each other (e.g., about axis 22).

### Internal Gearing

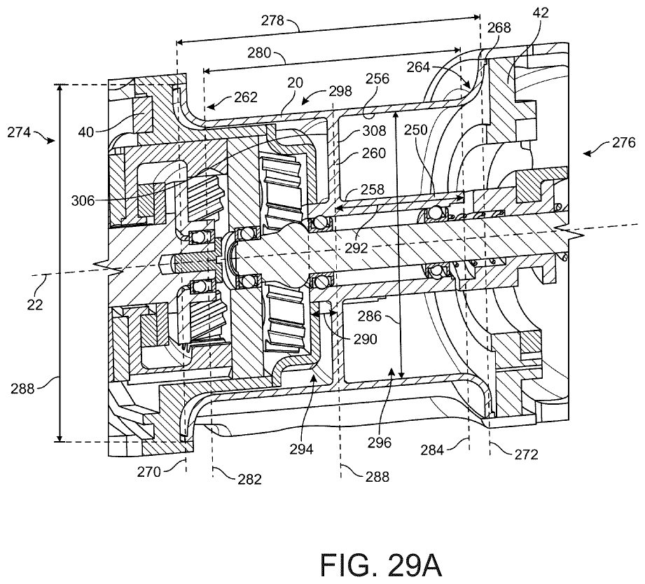

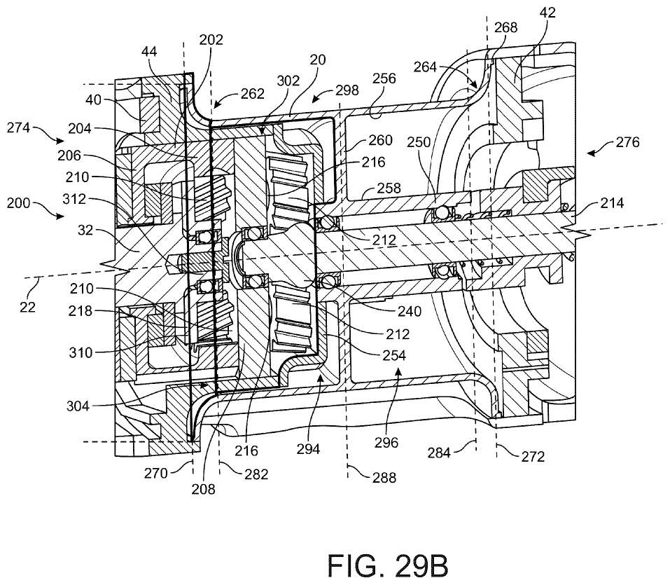

Referring particularly to FIGS. 29A-29B, spool 20 is shown in greater detail, according to an exemplary embodiment. Spool 20 may have a generally cylindrical shape including a straight portion, a cylindrical portion, etc., shown as straight portion 298, and curved outer portions, arcuate outer portions, outer radii, etc., shown as first curved portion 262 and second curved portion 264. Spool 20 is positioned between first body member 28 and second body member 30. In particular, spool 20 is positioned between first frame member 40 and second frame member 42. Spool 20 may be centered about axis 22 and extends along a longitudinal direction defined by axis 22 between first frame member 40 and second frame member 42.

Spool 20 also includes a first end, a first side, a proximate end, a proximate side, etc., shown as handle end 274, and a second end, a second side, a distal end, a distal side, etc., shown as distal end 276. First curved portion 262 is at handle end 274 of spool 20, while second curved portion 264 is at distal end 276 of spool 20. In some embodiments, first curved portion 262 is a portion of spool 20 that is most proximate first frame member 40 or first body member 28. Likewise, second curved portion 264 is a portion of spool 20 that is most distal first frame member 40 or first body member 28, or is most proximate second body member 30 or second frame member 42.

Spool 20 may include an inner diameter, an inner distance, an inner radial distance, etc., shown as inner diameter 286. Inner diameter 286 extends radially relative to axis 22 between an inner surface 256 of spool 20. In some embodiments, inner surface 256 is a radially inwards facing surface of spool 20. For example, inner surface 256 may be a cylindrical and radially inwards facing surface of straight portion 298. Spool 20 also includes an outer diameter, an outer distance, an outer radius, etc., shown as outer diameter 288. Outer diameter 288 is defined by an outer periphery, an outer edge, an outer surface, etc., of spool 20. For example, outer diameter 288 may be defined as a distance that extends between a radially outermost surface, periphery, edge, etc., of spool 20. In some embodiments, the radially outermost surface, periphery, edge, etc., of spool 20 is defined by first curved portion 262 and second curved portion 264. For example, first curved portion 262 and second curved portion 264 may curve radially outwards from straight portion 298 of spool 20 to define outer diameter 288.

Spool 20 has an overall longitudinal length 278 that extends between longitudinally opposite peripheries, edges, surfaces, faces, ends, etc., of spool 20. In some embodiments, overall longitudinal length 278 is greater than a longitudinal length 280 of straight portion 298. Longitudinal length 280 of straight portion 298 may extend between points on spool 20 where first curved portion 262 and second curved portion 264 begin. For example, first curved portion 262 may begin at handle end 274 of straight portion 298 while second curved portion 264 may begin at distal end 276 of straight portion 298. A first axis 282 extends radially through axis 22 at a longitudinal position along spool 20 where first curved portion 262 begins (e.g., at a transition between straight portion 298 and first curved portion 262). A second axis 284 extends radially through axis 22 at a longitudinal position along spool 20 where second curved portion 264 begins (e.g., at a transition between straight portion 298 and second curved portion 264). In some embodiments, first axis 282 extends radially through axis 22 at handle end 274 of straight portion 298. In some embodiments, second axis 284 extends radially through axis 22 at distal end 276 of straight portion 298. In some embodiments, first axis 282 extends radially through axis 22 at a longitudinal position of an apex of first curved portion 262. In some embodiments, second axis extends radially through axis 22 at a longitudinal position of an apex of second curved portion 262.

Spool 20 also defines a first outer axis 270, and a second outer axis 272. First outer axis 270 and second outer axis 272 extend radially through axis 22 at longitudinally outer edges, peripheries, surfaces, etc., of spool 20. For example, first outer axis 270 may extend radially through axis 22 at a longitudinally handle-most position, periphery, edge, surface, etc., of spool 20. For example, first outer axis 270 may be defined as an axis that extends radially through axis 22 at handle end 274 of first curved portion 262. Likewise, second outer axis 272 may extend radially through axis 22 at a longitudinally distal position, periphery, edge, surface, etc., of spool 20. In some embodiments, second outer axis 272 extends radially through axis 22 at distal end 276 of second curved portion 264.

It should be understood that any of first axis 282, second axis 284, first outer axis 270, and second outer axis 272 may define a plane. Any of the planes defined by first axis 282, second axis 284, first outer axis 270, and second outer axis 272 may be perpendicular to axis 22.

Spool 20 also includes a radially extending central axis 288, according to some embodiments. In some embodiments, central axis 288 extends radially through axis 22 at a longitudinal center position of spool 20. For example, central axis 288 may be equidistant longitudinally from both first axis 282 and second axis 284. In some embodiments, central axis 288 is equidistant longitudinally from both first outer axis 270 and second outer axis 272.

Spool 20 includes a central member, a central frame member, a radially extending support member, a support member, etc., shown as central member 260. Central member 260 extends radially between inner surface 256 of straight portion 298 of spool 20 and a radially outwards facing surface 258 of spool shaft 250. In some embodiments, central member 260 is longitudinally positioned along spool 20 at a central position of spool 20. For example, central member 260 may extend along central axis 288. In other embodiments, central member 260 is longitudinally offset (e.g., towards handle end 274 or towards distal end 276) along spool 20. In some embodiments, central axis 288 is defined as an axis that extends radially through axis 22 through central member 260. Central member 260 provides structural support between outer portions of spool 20 (e.g., between straight portion 298, first curved portion 262, and second curved portion 264) and spool shaft 250.

Central member 260 includes a first surface 306, and a second surface 308. First surface 306 and second surface 308 are spaced longitudinally apart along axis 22. First surface 306 faces handle end 274 of spool 20, while second surface 308 faces distal end 276 of spool 20. Straight portion 298 may be defined or divided into two straight portions. For example, straight portion 298 may be divided into a first straight portion and a second straight portion by central member 260 and/or by central axis 288. The first portion of straight portion 298 is proximate handle end 274, first body member 28, and/or first frame member 40. The second portion of straight portion 298 is proximate distal end 276, second body member 30, and/or second frame member 42.

Spool shaft 250 may also be defined by or divided into two portions by central member 260 and/or central axis 288. For example, spool shaft 250 may be divided into a first or proximate portion that is proximate handle end 274 of spool 20 (e.g., on a handle-side of central member 260 and/or central axis 288) and a second or distal portion that is proximate distal end 276 of spool 20 (e.g., on an opposite side of central member 260). In some embodiments, the first portion of spool shaft 250 has a longitudinal length 290 that is defined between a longitudinally outer periphery, a longitudinally outer edge, a longitudinally outer surface, a longitudinally outer most portion, a handle end 274, etc., of spool shaft 250 or an end of spool shaft 250 that is most proximate handle 36, first body member 28, first frame member 40, etc., and first surface 306. In some embodiments, the second portion of spool shaft 250 has a longitudinal length 290 that is defined between a longitudinally outer periphery, a longitudinally outer edge, a longitudinally outer surface, a longitudinally outer most portion, a distal end 276, etc., of spool shaft 250 or an end of spool shaft 250 that is most proximate second body member 30, second frame member 42, etc.

In some embodiments (e.g., as shown in FIG. 29A), longitudinal length 292 of the second portion of spool shaft 250 is greater than longitudinal length 290. In other embodiments, longitudinal length 292 is less than longitudinal length 290. In still other embodiments, longitudinal length 292 and longitudinal length 290 are substantially equal to each other.

Referring particularly to FIGS. 29A and 29B, spool 20 defines a first inner volume, a first area, a first space, etc., shown as first inner volume 294, and a second inner volume, a second area, a second space, etc., shown as second inner volume 296. First inner volume 294 is an inner volume defined by spool 20 that is on handle end 274 of central member 260. Second inner volume 296 is an inner volume defined by spool 20 that is on distal end 276 of central member 260. First inner volume 294 can be defined as areas, spaces, or volumes within spool 20 and may be defined by a radial axis extending through handle end 274 of spool shaft 250, radially outwards surface 250 of the first portion of spool shaft 250, first surface 306, inner surface 256 of the first portion of straight portion 298 and first curved portion 262, and first outer axis 270 (or by a plane that is perpendicular with axis 22 and is defined by first outer axis 270). Second inner volume 296 may be defined as areas, spaces, or volumes within spool 20 defined by a radial axis extending through distal end 276 of spool shaft 250, radially outwards facing surface 258 of spool shaft 250, second surface 308, inner surface 256 of the second portion of straight portion 298 and second curved portion 264, and second outer axis 272.

In some embodiments, first inner volume 294 is further divided into a first sub-volume 302 and a second sub-volume 304. First sub-volume 302 may be portions of first inner volume 294 that lie between central axis 288 and first axis 282. Second sub-volume 304 may be portions of first inner volume 294 that lie between first outer axis 270 and first axis 282. For example, first sub-volume 302 can be any inner volumes or spaces of spool 20 that are between first surface 306 and first axis 282 (e.g., at the transition between straight portion 298 and first curved portion 262). Second sub-volume 304 can be any spaces, inner volumes, voids, etc., within spool 20 that are between first axis 282 and first outer axis 270 (e.g., within spool 20 along first curved portion 262).

Referring particularly to FIG. 29B, compound gear set 200 is positioned within first inner volume 294 of spool 20. In some embodiments, compound gear set 200 is positioned partially within first inner volume 294 of spool 20. In other embodiments, compound gear set 200 is positioned completely within first inner volume 294 of spool 20. Compound gear set 200 can include various components that are positioned completely within first sub-volume 302, other components that are positioned completely within second sub-volume 304, and/or other components that are positioned at a transition between first sub-volume 302 and second sub-volume 304.

Referring still to FIG. 29B, carrier 208 can be positioned within first sub-volume 302. In some embodiments, carrier 208 is completely positioned within first sub-volume 302. For example, carrier 208 can be positioned between first axis 282 and central axis 288. Carrier 208 can be positioned at a longitudinal position along the first portion of straight portion 298 of spool 20. In some embodiments, carrier 208 is positioned at a longitudinal centerpoint of first sub-volume 302. In other embodiments, carrier 208 is offset from the longitudinal centerpoint of first sub-volume 302 (e.g., is closer to handle end 274 of first sub-volume 302 or is closer to distal end 276 of first sub-volume 302). In some embodiments, carrier 208 is positioned at a longitudinal centerpoint of first inner volume 294.

Referring still to FIG. 29B, planet gear shafts 216 extend through first sub-volume 302 and second sub-volume 304. In some embodiments, planet gear shafts 216 are completely positioned within first inner volume 294. For example, a first, proximate, or handle facing end of planet gear shafts 216 may terminate within second sub-volume 304, while a second, distal, or opposite end of planet gear shafts 216 may terminate within first sub-volume 302. In some embodiments, the first end of planet gear shafts 216 terminates, ends, or lies at the transition between first sub-volume 302 and second sub-volume 304. For example, the first end of planet gear shafts 216 may terminate substantially at first axis 282. In some embodiments, the first end of planet gear shafts 216 terminates or extends up to an outermost periphery, edge, border, etc., of second sub-volume 304 (e.g., at first outer axis 270). In still other embodiments, the first end of planet gear shafts 216 terminates at a position beyond the outermost border of second sub-volume 304 (e.g., at a longitudinal position that is beyond handle 36 or beyond first outer axis 270). Planet gear shafts 216 may extend across, intersect, etc., the transition between the first sub-volume 302 and the second sub-volume 304.

Referring still to FIG. 29B, input planetary gears 210 are positioned at the first ends of planet gear shafts 216. In some embodiments, input planetary gears 210 are press fit, keyed, etc., or otherwise rotatably fixedly coupled with planet gear shafts 216 at the first ends of planet gear shafts 216. In some embodiments, input planetary gears 210 are integrally formed with the first ends of planet gear shafts 216.

Input planetary gears 210 may be positioned within first inner volume 294. In some embodiments, input planetary gears 210 are positioned at the transition between first sub-volume 302 and second sub-volume 304. For example, input planetary gears 210 can be positioned longitudinally such that input planetary gears 210 intersect with or lie along first axis 282. In some embodiments, a portion of input planetary gears 210 is positioned within second sub-volume 304 while another portion of input planetary gears 210 is positioned within first sub-volume 302. In some embodiments, input planetary gears 210 are positioned longitudinally such that first axis 282 extends through a longitudinal centerpoint of input planetary gears 210. In other embodiments, input planetary gears 210 are positioned longitudinally such that first axis 282 extends through a portion of input planetary gears 210 that is offset from the longitudinal center of input planetary gears 210. For example, a portion of input planetary gears 210 that lies within first sub-volume 302 may have a longitudinal length that is substantially equal to, greater than, or less than, a longitudinal length of a portion of input planetary gears 210 that lies within second sub-volume 304. In other embodiments, planet gear shafts 216 have a longitudinal length such that input planetary gears 210 lie completely within first sub-volume 302. In other embodiments, planet gear shafts 216 have a longitudinal length such that input planetary gears 210 lie completely within second sub-volume 304.

Referring still to FIG. 29B, output shaft 214 may extend through both first inner volume 294 and second inner volume 296. In some embodiments, output shaft 214 extends into and terminates within first sub-volume 294. For example, teeth 240 can be positioned completely within first sub-volume 302.

Referring still to FIG. 29B, ring member 202 can extend partially into first inner volume 294. For example, ring gear portion 204 of ring member 202 may lie completely within first inner volume 294, while engagement portion 206 is outside of first inner volume 294. In some embodiments, engagement portion 206 is positioned within an inner volume that is defined by first body member 28. Engagement portion 206 may extend into first sub-volume 302 such that a portion of engagement portion 206 lies within first sub-volume 302 while another part of engagement portion 206 lies within second sub-volume 304. In some embodiments, engagement portion 206 intersects, crosses, extends through, etc., the transition between first sub-volume 302 and second sub-volume 304. In some embodiments, engagement portion 206 is completely positioned within first sub-volume 302. In other embodiments, engagement portion 206 is completely positioned within second sub-volume 304. In some embodiments, engagement portion 206 terminates at the transition between first sub-volume 302 and second sub-volume 304. For example, a longitudinally facing surface of engagement portion 206 that faces central axis 288 may intersect the transition between first sub-volume 302 and second sub-volume 304 (e.g., first axis 282). In some embodiments, ring member 202 is completely positioned within first inner volume 294.

Referring still to FIG. 29B, body member 44 can extend at least partially into first inner volume 294. In some embodiments, body member 44 extends longitudinally across or through second sub-volume 304, and terminates in first sub-volume 302. Inner body member 254 may be fixedly coupled or integrally formed with body member 44 and can be positioned completely within first sub-volume 302. In some embodiments, body member 44 extends longitudinally past first curved portion 262 and along at least a portion of straight portion 298 of spool 20.

Referring still to FIG. 29B, flange member 218 is positioned at least partially within first inner volume 294. Flange member 218 can include a radially extending portion 310, and a longitudinally extending portion 312. Radially extending portion 310 may extend longitudinally across first outer axis 270 (e.g., into second sub-volume 304, past the outer periphery of handle end 274 of spool 20). Longitudinally extending portion 312 may extend across the transition between first sub-volume 302 and second sub-volume 304.

Input shaft 32 may also extend into first inner volume 294 of spool 20. In some embodiments, input shaft 32 terminates or ends at the transition between first sub-volume 302 and second sub-volume 304. In other embodiments, input shaft 32 terminates within first sub-volume 302. In still other embodiments, input shaft 32 terminates within second sub-volume 304.

Advantageously, at least a portion of compound gear set 200 is positioned within first inner volume 294 of spool 20, thereby facilitating a more compact reel 12. The various components of compound gear set 200 may be translationally fixedly coupled with first body member 28, first structural member 40, and/or body member 44. Spool 20 may function as both a fishing line retrieval, storage, and let-out apparatus in addition to enclosing, protecting, etc., components of compound gear set 200. It should be understood that while spool 20 is shown and described as including first curved portion 262 and second curved portion 264, spool 20 can be a substantially hollow cylindrical, barrel, or spool member that does not include first curved portion 262 and second curved portion 264.

### Configuration of Exemplary Embodiments

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claim.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “of” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claim.

What is claimed is:

1. A fishing apparatus, comprising:
a body defining a first end and a second end;
a spool extending between the first end and the second end;
a drive configured to receive an input torque at the first end, and drive the spool through a coupling at the second end, wherein the drive comprises a gear positioned at least partially within an inner volume of the spool; and
an output shaft, wherein the output shaft is configured to receive an output torque from the gear.

2. The fishing apparatus of claim 1, wherein the spool comprises a spool shaft having a central bore, the spool shaft positioned centrally within the spool.

3. The fishing apparatus of claim 2, wherein the output shaft extends through the central bore of the spool shaft, the output shaft selectably rotatably coupled with the spool.

4. The fishing apparatus of claim 2, wherein the drive comprises a spool engagement mechanism at an end of the spool shaft that is proximate the second end of the body, the spool engagement mechanism configured to transition between a first state to fixedly couple the spool with the output shaft so that the spool and the output shaft rotate in unison and a second state to de-couple the spool from the output shaft so that the spool and the output shaft are configured to rotate relative to each other.

5. The fishing apparatus of claim 4, wherein the spool engagement mechanism comprises:
an engagement member configured to translate along the output shaft between a first position and a second position, the engagement member fixedly coupled with the output shaft and comprising an interfacing portion configured to engage an interfacing portion of the spool shaft, wherein the interfacing portion of the engagement member and the interfacing portion of the spool shaft are configured to interlock with each other to rotatably fixedly couple the output shaft with the spool so that the output shaft and the spool rotate in unison when the engagement member is in the first position.

6. The fishing apparatus of claim 5, wherein the engagement member comprises an annular groove configured to receive a corresponding portion of a linkage.

7. The fishing apparatus of claim 5, wherein the spool engagement mechanism further comprises a spring configured to bias the engagement member into the first position.

8. The fishing apparatus of claim 6, wherein the linkage is positioned at the second end of the body, the linkage configured to receive a user input to transition the engagement member between the first position and the second position.

9. The fishing apparatus of claim 1, wherein the drive receives the input torque from an input shaft rotatably coupled to the spool.

10. The fishing apparatus of claim 9, wherein the input shaft is rotatably coupled with a handle.

11. A fishing rod assembly, comprising:
a rod; and
a reel coupled with the rod, the reel comprising:
a body defining a first end and a second end;
a spool extending between the first end and the second end;
a spool drive mechanism configured to receive an input torque at the first end, and drive the spool through a coupling at the second end, wherein the spool drive mechanism comprises a gear positioned at least partially within an inner volume of the spool;
an output shaft, wherein the output shaft is configured to receive an output torque from the gear.

12. The fishing rod assembly of claim 11, wherein the spool comprises a spool shaft having a central bore, the spool shaft positioned centrally within the spool.

13. The fishing rod assembly of claim 12, wherein the output shaft extends through the central bore of the spool shaft, the output shaft selectably rotatably coupled with the spool.

14. The fishing rod assembly of claim 12, wherein the spool drive mechanism comprises a spool engagement mechanism at an end of the spool shaft that is proximate the second end of the body, the spool engagement mechanism configured to transition between a first state to fixedly couple the spool with the output shaft so that the spool and the output shaft rotate in unison and a second state to de-couple the spool from the output shaft so that the spool and the output shaft are configured to rotate relative to each other.

15. The fishing rod assembly of claim 14, wherein the spool engagement mechanism comprises:
an engagement member configured to translate along the output shaft between a first position and a second position, the engagement member fixedly coupled with the output shaft and comprising an interfacing portion configured to engage an interfacing portion of the spool shaft, wherein the interfacing portion of the engagement member and the interfacing portion of the spool shaft are configured to interlock with each other to rotatably fixedly couple the output shaft with the spool so that the output shaft and the spool rotate in unison when the engagement member is in the first position.

16. The fishing rod assembly of claim 15, wherein the engagement member comprises an annular groove configured to receive a corresponding portion of a linkage.

17. The fishing rod assembly of claim 15, wherein the spool engagement mechanism further comprises a spring configured to bias the engagement member into the first position.

18. The fishing rod assembly of claim 16, wherein the linkage is positioned at the second end of the body, the linkage configured to receive a user input to transition the engagement member between the first position and the second position.

19. The fishing rod assembly of claim 11, wherein the spool drive mechanism receives the input torque from an input shaft rotatably coupled to the spool.

20. A fishing reel, comprising:
a spool;
a drive configured to receive an input torque at a first end, and drive the spool through a coupling at a second end, wherein the drive comprises a gear set positioned at least partially within an inner volume of the spool; and
an output shaft, wherein the output shaft is configured to receive an output torque from the gear set.
